(19) United States
(12) Patent Application Publication
(10) Pub. No.: US 2003/0123755 A1
(43) Pub. Date: Jul. 3, 2003

(54) Method of detecting sucking-end position of suction nozzle, and detecting tool and assisting kit used for the method

(75) Inventor: Koji Shimizu, Nukata-gun (JP)

Correspondence Address: OLIFF & BERRIDGE, PLC, P.O. BOX 19928, ALEXANDRIA, VA, 22320, US

(73) Assignee: FUJI MACHINE MFG. CO., LTD., Chiryu-shi (JP)

(21) Appl. No.: 10/322,633

(22) Filed: Dec. 19, 2002

(30) Foreign Application Priority Data
Dec. 28, 2001 (JP) 2001-399742

(51) Int. Cl. G06K 9/36; G06K 9/00

(52) U.S. Cl. 382/291; 382/141

(57) ABSTRACT

A method of detecting a sucking-end position of a suction nozzle used to hold an object by suction, which uses a detecting tool having a contact surface for contact with the sucking end of the suction nozzle when the detecting tool is held by suction by the suction nozzle, and an imaged surface which is opposite to the contact surface and which is imaged when the detecting tool is held by the suction nozzle such that a center of an image of the imaged surface taken in an axial direction of the suction nozzle lies on an axis of the suction nozzle, wherein a center position of the sucking end of the suction nozzle with respect to a nominal position of its axis is detected in a plane perpendicular to the axial direction, on the basis of the image of the imaged surface of the detecting tool. Also disclosed in a detection assisting kit including a tool container accommodating at least one detecting tool such that one detecting tool is pickup up by the suction nozzle at a predetermined tool-pickup position.

The present application is based on Japanese Patent Application No. 2001-399742 filed Dec. 28, 2001, the content of which is incorporated herein by reference.

### BACKGROUND OF THE INVENTION

1. Field of the Invention

The present invention relates in general to a method of detecting a sucking-end position of a suction nozzle arranged to hold an object by suction at its sucking end under a negative pressure, a detecting tool used for the detecting method, and a detection assisting kit including the detecting tool.

2. Discussion of Related Art

For example, a suction nozzle arranged to hold an object by suction is used by a component-mounting device in an electric-component mounting system constructed to mount electric components (including electronic components) on a circuit substrate. The component-mounting device is arranged to receive each electric component from a component-supplying device, and transfers the electric component onto a surface of the circuit substrate. The suction nozzle is used as an electric-component holding device of a component-mounting head included in the component-mounting device. The suction nozzle is constructed to hold the object in the form of the electric component by suction at its sucking end under a negative pressure. In the electric-component mounting system described above, the suction nozzle is required to hold the electric component by suction with high stability, and to mount the electric component on the circuit substrate, with high accuracy of positioning of the electric component with respect to the circuit substrate. To meet these requirements, the sucking-end position of the suction nozzle must be detected.

In the field of mounting of electric components on the circuit substrates, there has been considered a method of detecting the sucking-end position of the suction nozzle, wherein a reference piece in place of an electric component is held by the suction nozzle, and is mounted on a reference substrate, and the sucking-end position of the suction nozzle is obtained on the basis of a result of mounting of the reference piece. However, the sucking-end position of the suction nozzle obtained in this method includes positioning errors of various devices, other than positioning errors of the sucking-end position. Accordingly, the method suffer from considerable difficulty to accurate detection of the sucking-end position of the suction nozzle. Further, the method requires an operation to mount the reference piece on the reference substance, and an operation to inspect the result of the mounting, which operations are relatively cumbersome.

### SUMMARY OF THE INVENTION

It is therefore an object of the present invention to accurately detect the sucking-end position of a suction nozzle which is used to hold an object, in a system, apparatus or equipment such as an electric-component mounting system, which is required to perform a highly accurate or precise operation. This object may be achieved according to any one of the following modes of the present invention, in the form of a method of detecting the sucking-end position of a suction nozzle arranged to hold an object, and a detecting tool and a detection assisting kit used to detect the sucking-end position of the suction nozzle. Each of the following modes of the invention is numbered like the appended claims and depends from the other mode or modes, where appropriate, for easier understanding of technical features disclosed in the present application and possible combinations of those features. However, it is to be understood that the invention is not limited to those technical features or combinations thereof, and that any one of a plurality of technical features described below with respect to any one mode of the invention may be a subject matter of the present invention, without the other technical feature or features being combined with that one technical feature.

(1) A method of detecting a position of a sucking end of a suction nozzle arranged to hold an object by suction at the sucking end under a negative pressure, comprising the steps of:

preparing a detecting tool having (a) a contact surface for contact with the sucking end of the suction nozzle when the detecting tool is held by suction by the suction nozzle, and (b) an imaged surface which is opposite to the contact surface and which is imaged when the detecting tool is held by suction by the suction nozzle such that a center of an image of the imaged surface taken in an axial direction of the suction nozzle lies on an axis of the suction nozzle;

holding the detecting tool by suction on the suction nozzle such that the contact surface is in contact with the sucking end;

taking the image of the imaged surface of the detecting tool in the axial direction of the suction nozzle; and

detecting a center position of the sucking end of the suction nozzle in a plane perpendicular to the axial direction, with respect to a nominal position of the axis of the suction nozzle, on the basis of image data representative of the image of the image surface.

For easier understanding of the method of the present invention, the method will be described in detail, with respect to the suction nozzle used as an electric-component holding device of a component-holding head provided on an electric-component mounting system. However, the application of the present method is not limited to the suction nozzle used in such an electric-component mounting system. The electric-component mounting system includes a component-supplying device arranged to supply electric components, a circuit-substrate holding device arranged to hold a circuit substrate, and a component-mounting device arranged to receive the electric component from the component-supplying device and mount the electric component on a component-mounting surface of the circuit substrate held by the circuit-substrate holding device. The component-mounting device includes a component-mounting unit having a component-mounting head, and a moving-unit moving device arranged to move or drive the component-mounting head from the component-supplying device to a component-mounting position. In the electric-component mounting system constructed as described above, the suction nozzle is attached to the lower end of the component-mounting head, and functions to hold the electric component by suction at its sucking end when a negative pressure is applied to the suction nozzle, and release the electric component when the negative pressure is released from the suction nozzle or when a positive pressure is applied to the suction nozzle. Since an operation to mount the electric components on the circuit substrate is required to assure a high degree of positioning of the electric components on the circuit substrate, the electric-component mounting system is provided with a component imaging device arranged to take an image of each electric component as held by suction at the sucking end of the suction nozzle, and an image-data processing device arranged to process image data representative of the image of the electric component, to obtain positioning errors or amounts of deviation of the electric component with respect to the axis or centerline of the component-mounting head, so that these positioning errors are eliminated by compensation upon mounting of the electric component on the circuit substrate, so that the electric component is mounted at the predetermined component-mounting spot, with high positioning accuracy. In this respect, the center position of the sucking end of the suction nozzle must be detected with high accuracy in the component-mounting operation.

To mount the electric component on the circuit substrate with high positioning accuracy, the electric component must be held by suction by the suction nozzle while the suction nozzle has a nominal attitude. Where the actual center position of the sucking end of the suction nozzle deviates from the nominal center position due to bending of the suction nozzle, for instance, the suction nozzle may fail to hold the electric component at a predetermined relative position therebetween when the suction nozzle receives the electric component from the component-supplying device. When the electric component is not held at the predetermined position relative to the sucking end of the suction nozzle, the electric component held by the suction nozzle may be inclined, or the electric component may be held at a surface different from the intended contact surface for contact with the sucking end of the suction nozzle. In some cases, the electric component may fall from the suction nozzle due to an insufficient suction force applied to the electric component. These drawbacks are relatively likely to take place particularly when the size of the electric component is relatively small. In view of a recent tendency of reduction in the size of the electric components, the suction nozzle is required to hold the electric components by suction with high stability. Where the electric component has dimensions of about 0.6 mm×about 0.3 mm, for example, positional deviation of as small as about 0.2 mm of the suction nozzle in the plane perpendicular to its axis direction has a high possibility of occurrence of any drawbacks as mentioned above. For stable holding of the electric component by suction by the suction nozzle, the center position of the sucking end of the suction nozzle is required to be accurately detected.

The method of detecting the position of the sucking end of the suction nozzle according to the above mode (1) of this invention uses the detecting tool for detecting the sucking-end position of the suction nozzle. This detecting tool has (a) a contact surface for contact with the sucking end of the suction nozzle when the detecting tool is held by suction by the suction nozzle, and (b) an imaged surface which is opposite to the contact surface and which is imaged when the detecting tool is held by suction by the suction nozzle such that the center of an image of the imaged surface taken in the axial direction of the suction nozzle lies on the axis of the suction nozzle. Generally, the suction nozzle has a cylindrical nozzle portion, and is arranged to hold the object in the form of the electric component by suction at the sucking end of the nozzle portion. For this type of suction nozzle, a representative or typical example of the detecting tool takes the form of a sphere. In the case of the spherical detecting tool, any part spherical surface of the detecting tool may function as the contact surface, and the hemispherical surface of the detecting tool which is opposite to the contact surface in the axial direction of the suction nozzle when the detecting tool is held by the suction nozzle is visible in the axial direction and can therefore serve as the imaged surface whose image is to be taken.

When the spherical detecting tool is held by suction by the cylindrical nozzle portion of the suction nozzle, the center of the detecting tool, that is, the center of the sphere lies on the axis of the suction nozzle (more precisely, on the axis of the sucking end portion of the suction nozzle), irrespective of a part-spherical surface of the sphere which is selected as the contact surface for contact with the sucking end of the nozzle portion. Where the center position of the sucking end of the suction nozzle is offset from the nominal position of the axis of the suction nozzle, the sucking end of the suction nozzle is not aligned with the center of the spherical detecting tool when the suction nozzle is moved with the component-mounting head to a nominal position at which the detecting tool is located and held by suction by the suction nozzle. In this case, however, the spherical shape of the detecting tool permits the center of the spherical detecting tool to be brought into alignment with the axis of the suction nozzle when the detecting tool is sucked by the suction nozzle.

When the imaged surface in the form of the hemispherical surface of the spherical detecting tool held by suction by the suction nozzle is imaged in the axial direction in which the hemispherical surface is opposite to the contact surface, an image of the imaged surface has a circular shape whose center is aligned with the axis of the suction nozzle. In other words, the projection image of the imaged surface of the spherical detecting tool taken in the axial direction of the suction nozzle is circular, having a center lying on the axis of the suction nozzle. The image of the imaged surface opposite to the contact surface always has a circular shape having the same diameter, irrespective of a part-spheri1cal surface of the spherical detecting tool which serves as the contact surface for contact with the sucking end of the nozzle portion. Namely, the center position of the sucking end of the suction nozzle can be easily detected on the basis of the center position of the circular profile of the image of the imaged surface when any part of the spherical surface of the sphere of the detecting tool is used as the contact surface. Thus, the center position of the sucking end of the suction nozzle can be accurately detected by holding the spherical detecting tool by suction on the suction nozzle, and taking an image of the imaged surface of the detecting tool in the axis direction of the suction nozzle.

The detecting tool used in the method according to the above mode (1) may have any shape other than the spherical one described above, for example, may have a hemispherical shape. The hemispherical detecting tool has a hemispherical surface which provides as the contact surface. Like the spherical detecting tool, the hemispherical detecting tool can be aligned with the axis of the suction nozzle when the detecting tool is held by suction by the suction nozzle, even when the actual center position of the sucking end of the suction nozzle is offset from its nominal position. That is, the center of an imaginary sphere which is partially constituted by the above-indicated hemispherical surface is brought into alignment with the axis of the suction nozzle when the hemispherical detecting tool is sucked by the suction nozzle. Thus, the detecting tool used in the method of the above mode (1) desirably has a part-spherical contact surface for contact with the sucking end of the suction nozzle. The hemispherical detecting tool has a circular flat surface which cooperates with the hemispherical surface to define a hemisphere of the detecting tool and which serves as the imaged surface. In the case of the hemispherical detecting tool, the center of the above-indicated imaginary sphere lies on the circular flat surface and is aligned with the center of the circular flat surface. Accordingly, the center of the production image of the circular flat surface serving as the imaged surface lies on the axis of the suction nozzle, irrespective of any part-spherical surface of the hemisphere which is selected as the contact surface. Where the hemispherical detecting tool is held by the suction nozzle such that the circular flat surface is inclined relative to the plane perpendicular to the axis of the suction nozzle, an image of the circular flat surface taken in the axial direction is elliptical, but the center of this elliptical image is located on the axis of the suction nozzle. Accordingly, the center position of the sucking end of the suction nozzle can be easily and accurately detected on the basis of image data representative of the image of the circular flat surface of the hemispherical detecting tool, as in the case where the spherical detecting tool is used.

It will be understood from the foregoing description that the detecting tool may have a hemispherical or any other part-spherical surface serving as the contact surface, and a circular flat or conical surface which has a center of an imaginary sphere partially defined by the part-spherical surface and which provides as the imaged surface whose image is taken. The circular flat or conical surface may be provided with a suitable detecting mark located at its center and serving as the imaged surface. Thus, the present method may use a detecting tool of any one of various configurations.

The image of the imaged surface of the detecting tool is taken in a direction parallel to the nominal axis of the suction nozzle, so that this image represents the center position of the imaged surface of the detecting tool in the plane perpendicular to the nominal axis, that is, the center position of the sucking end of the suction nozzle in this plane, more specifically, the direction and amount of deviation or misalignment of the center position of the sucking end with respect to the nominal position of the axis of the suction nozzle, in the above-indicated plane. Normally, the suction nozzle is held by the component-mounting head such that the axis of the suction nozzle is parallel with the axis of the component-mounting head. Usually, the suction nozzle and the component-mounting head are designed such that their axes are aligned with each other. Namely, the nominal axis of the suction nozzle is aligned with that of the component-mounting head. In this case, therefore, the amount of deviation of the sucking end of the suction nozzle with respect to the nominal axis of the component-mounting head can be easily detected on the basis of an image of the sucking end of the suction nozzle taken when the axis of the head is aligned with the optical axis of the imaging device. When the axis of the component-mounting head and the optical axis of the imaging device are not aligned with each other, the direction and amount of misalignment or deviation of the axis of the component-mounting head with respect to the optical axis of the imaging device, and the direction and amount of misalignment or deviation of the sucking end of the suction nozzle with respect to the axis of the component-mounting head can both be obtained on the basis of a plurality of images of the sucking end of the suction nozzle at respective angular positions of the component-mounting head. These direction and amount of misalignment thus obtained by taking the images of the sucking end of the suction nozzle are used compensation data for adjusting the component-mounting positions, for mounting the electric components on the circuit board with high positioning accuracy. The detected direction and amount of misalignment of the sucking end of the suction nozzle with respect to the axis of the component-mounting head can also be used when the suction nozzle receives the electric component from the component-supplying device, that is, when the component-mounting head is moved to move the suction nozzle to the component-receiving position at which the suction nozzles receives and hold the electric component supplied from the component-supplying device. Accordingly, the suction nozzle can hold by suction the electric component with high stability in the accuracy of positioning of the electric component relative to the sucking end.

Where the detecting tool used to detect the sucking-end position of the suction nozzle is not arranged to assure that the center of an image of the imaged surface of the detecting tool taken in the axial direction of the suction nozzle lies on the axis of the suction nozzle, the center of the detecting tool held by suction by the suction nozzle moved by the component-mounting head to a predetermined position to hold the detecting tool is not necessarily aligned with the center of the sucking end of the suction nozzle, where the sucking end of the suction nozzle is misaligned with the axis of the component-mounting head. In the method according to the present invention, therefore, the detecting tool has the imaged surface which is imaged when the detecting tool is held by the suction nozzle such that the center of the image of the imaged surface taken in the axis direction of the suction nozzle lies on the axis of the suction nozzle, so that the sucking-end position of the suction nozzle can be accurately and easily detected on the basis of the position of the center of the image of the imaged surface.

The imaging device used to take the image of the imaged surface of the detecting tool is not particularly limite4d, and may include a suitable image-taking device, for example, a CCD camera and a line sensor, provided that the image of the imaged surface of the detecting tool can be taken by the image-taking device in the axial direction of the suction nozzle, toward the imaged surface. However, the position of the image-taking device is not limited to a position which is spaced from the detecting tool in the axis direction of the suction nozzle. Namely, an image light emitted from the imaged surface in the axis direction of the suction nozzle need not be directly incident upon the image-taking device in the axial direction, but may be suitably guided by a light guiding device, which may include a reflecting mirror or mirrors and which is arranged to change a path of propagation of the image light so that the image light is eventually incident upon the image-taking device. Image data representative of the image of the imaged surface of the detecting tool taken by the imaging device may be processed by an image-data processing computer, to detect the center position of the sucking end of the suction nozzle.

(2) A method according to the above mode (1), wherein the step of preparing a detecting tool comprises preparing a detecting tool such that the image of the imaged surface of the detecting tool is distinguishable from any other image within a field of vision in which the image of the imaged surface is taken.

In an electric-component mounting system, the position of an electric component as held by the suction nozzle is detected by taking a front image of the electric component with a so-called “front light” or a silhouette image of the electric component with a so-called “back light”. Like the electric component, the detecting tool as held by the suction nozzle is imaged to take either the front image or the silhouette image. In either of these two cases, the imaged surface of the detecting tool is desirably easily distinguishable from the background. For instance, a portion of the component-mounting device (including the suction nozzle) that carries the component-mounting head may appear in the background. In this case, the imaged surface of the detecting tool is required to be arranged such that the taken image of the imaged surface has a high degree of contrast with respect to any other image within the field of vision, so that the sucking-end position of the suction nozzle can be accurately detected on the basis of the image of the imaged surface of the detecting tool.

This aspect of the detecting tool will be described in greater detail, where the detecting tool is a spherical tool. When the front image of the spherical detecting tool is taken with a visible light having a continuous spectrum of wavelength, the background is colored relatively black, while the imaged surface is colored relatively white. When the silhouette image of the spherical detecting tool is taken, on the other hand, the imaged surface is colored relatively black. The light used for imaging the detecting tool is not limited to the visible light, but may be a ultraviolet light or an infrared light. The light used may be a monochromic light or may have a selected band of wavelength. In such cases, the color of the images surface is determined by taking account of the reflectivity or absorptance with respect to the specific light used. Where the spherical detecting tool whose surface has a relatively high specular gloss or reflection is used, the specular gloss of the images surface may obscure the profile of the imaged surface as represented by its image taken. In this respect, it is preferable to use a spherical detecting tool that has a specular gloss or reflection as low as possible.

In the case of the hemispherical detecting tool, an edge portion of the hemispherical surface (contact surface) of the detecting tool may be imaged together with the circular flat surface (imaged surface). In this respect, the hemispherical detecting tool is desirably arranged such that the image of the circular flat surface is distinguishable from not only the background but also the hemispherical surface. Where a front image of the hemispherical detecting tool is taken, it is preferable that the hemispherical surface is relatively black while the circular flat surface is relatively white.

(3) A method according to the above mode (1) or (2), wherein the step of taking the image of the imaged surface of the detecting tool comprises taking a front image of the detecting tool with a light reflected from the imaged surface.

When the front image of the electric component as held by the suction nozzle is taken with the front light, the suction nozzle is usually colored so that the image of the suction nozzle is hidden in the background, to prevent the image of the suction nozzle from obscuring the image of the electric component. Where the electric component is small, the electric component held by suction at the sucking end of the suction nozzle may be positioned within the outer profile of the sucking end face of the suction nozzle, as seen in the axial direction of the suction nozzle. In view of this, the surface of the suction nozzle (including the sucking end face) is preferably colored such that the image of the suction nozzle is hidden in the background of the image. While the image of the sucking end face of the suction nozzle may be taken to detect the position of the sucking end, this detection is difficult where the suction nozzle is colored such that the image of the suction nozzle is hidden in the background. In the method of the present invention, the image of the detecting tool held by the suction nozzle is taken to detect the position of the sucking end of the suction nozzle. The method according to the above mode (3) is particularly effective to detect the position of the sucking end face of the suction nozzle whose front image is difficult to take with the front light.

When the silhouette image of the detecting tool is taken, the silhouette image represents the entire outer profile of the detecting tool as seen in the axial direction. Therefore, the profile of the imaged surface cannot be taken as distinguished from the entire outer profile of the detecting tool, where any portion of the contact surface lies within the entire outer profile. In the case of the hemispherical detecting tool, a portion of the contact surface in the form of the hemispherical surface partially forms the entire outer profile of the detecting tool as seen in the axial direction. Thus, the configuration of the detecting tool is limited when the silhouette image of the detecting tool is taken. In this respect, the limitation in the configuration of the detecting tool is relatively small, when the front image of the hemispherical detecting tool is taken such that the image of the circular flat surface is distinguishable from any other image within the field of vision. Accordingly, the front image is generally advantageous over the silhouette image.

(4) A method according to any one of the above modes (1)-(3), wherein the step of preparing a detecting tool comprises preparing a spherical tool as said detecting tool.

As described above, the position of the sucking end of the suction nozzle can be detected on the basis of either the front image or the silhouette image of the spherical detecting tool. Further, any part-spherical surface of the spherical detecting tool can serve as the contact surface. In addition, the spherical detecting tool is easier to manufacture and handle and more stable in shape, in the absence of any edge, than detecting tools of any other shape. As described below, the spherical detecting tool is easily movable by rolling, and can be located at a predetermined position at which the detecting tool is picked up by the suction nozzle, when the sucking-end position of the suction nozzle is automatically detected by automatically locating the detecting tool and holding it by suction by the suction nozzle. Where the suction nozzle is cylindrical having a center bore, the spherical detecting tool desirably has a diameter larger than an inside diameter of the suction nozzle, for preventing the spherical detecting tool from being drawn into the center bore of the suction nozzle. In this case, the diameter of the spherical detecting tool need not be larger than the center bore of the suction nozzle as measured at its sucking open end. Where the sucking end portion of the center bore of the suction nozzle is tapered with its diameter gradually increasing in the axial direction toward the extreme open end, the diameter of the spherical detecting tool may be smaller than the diameter of the center bore as measured at the extreme open end.

(5) A method according to the above mode (4), wherein the spherical tool is a ball having a diameter larger that an outside diameter of the suction nozzle.

The use of the detecting tool in the form of a ball according to the above mode (5) is advantageous where the suction nozzle has a cylindrical nozzle portion arranged to hold by suction the electric component at its sucking end. The ball as held by suction by the suction nozzle is imaged in the axial direction of the suction nozzle, toward the sucking end face of the suction nozzle, while the suction nozzle is hidden by the ball in the optical path between the imaging device and the ball. Since the diameter of the ball is larger than the outside diameter of the suction nozzle, more precisely, than the outside diameter of the nozzle portion, the sucking end face of the suction nozzle lies within the diameter of the ball, and the radially outer portion of the sucking end face cannot be imaged, when the actual axis of the suction nozzle is aligned with the nominal axis. Where the diameter of the ball is not larger than the outside diameter of the nozzle portion, the radially outer portion of the sucking end face is imaged, and the image of this radially outer portion of the sucking end face may obscure the image of the ball. The method according to the above mode (5),which does not suffer from this drawback, permits accurate detection of the sucking-end position of the suction nozzle.

Where the sucking-end position of the suction nozzle is misaligned with the nominal axis of the suction nozzle, due to bending or flexure thereof, a proximal end portion or an axially intermediate portion of the suction nozzle may be imaged. In view of this, the diameter of the ball is desirably large enough to prevent imaging of the proximal end portion or axially intermediate portion of the suction nozzle even where the suction nozzle has some degree of bending or flexure within a tolerable range. Described more specifically, the diameter of the ball is preferably at least 1.3 times, more preferably at least 1.5 times that of the outside diameter of the suction nozzle (its nozzle portion), depending upon the length of the suction nozzle. Since the detecting tool is held by suction by the suction nozzle under a negative pressure, an increase in the diameter of the ball which causes an increase in the weight of the ball tends to reduce the stability of suction of the ball on the sucking end face of the suction nozzle. In view of this, the upper limit of the diameter of the ball is preferably 2.5 times, more preferably 2 times that of the outside diameter of the suction nozzle.

(6) A method according to the above mode (4), wherein the spherical tool is a ball having a diameter smaller than an outside diameter of the suction nozzle.

Where the spherical detecting tool may have a diameter smaller than the outside diameter of the suction nozzle, as in the method according to the above mode (6). The use of the spherical detecting tool having a diameter larger than the outside diameter of the suction nozzle is preferable where the accuracy of detection of the sucking-end position of the suction nozzle is adversely influenced by an image of the radially outer portion of the suction nozzle taken together with the image of the detecting tool. Where such influence is not expected, for instance, where the image of the radially outer portion or sucking end face of the suction nozzle is hidden in the background, the detecting tool may be a spherical tool having a diameter smaller than the outside diameter of the sucking end of the suction nozzle. When the spherical ball is held by suction on the sucking end face of the suction nozzle, the sucking end face of the suction nozzle is spaced from the center of the spherical tool by a given distance in the axial direction of the suction nozzle. When the suction nozzle is bent or flexed (curved), this spacing distance in the axial direction influences the center position of the sucking end of the suction nozzle in the plane perpendicular to the axial direction. The amount of this influence of the axial spacing distance is not so large when the diameter of the spherical tool is relatively small, and need not be taken into account in the detection of the center position of the sucking end of the suction nozzle, provided the amount of bending or flexure of the suction nozzle is within the tolerable range. When the diameter of the spherical tool is relatively large, the influence of the axial spacing distance indicated above is not negligible. That is, the amount of influence of the axial spacing distance decreases with a decrease in the diameter of the spherical tool, so that the accuracy of detection of the center position of the sucking end of the suction nozzle increases with the decrease in the diameter of the spherical tool. Accordingly, the diameter of the ball as the spherical detecting tool is preferably minimized, provided the image of the radially outer portion or sucking end face of the suction nozzle does not obscure the image of the ball, and unless the ball is likely to be drawn into the center bore of the suction nozzle or difficult to be removed from the sucking end face.

(7) A method according to any one of the above modes (1)-(3), wherein the step of preparing a detecting tool comprises preparing a detecting tool having a part-spherical surface as the contact surface.

(8) A method according to the above mode (7), wherein the imaged surface of the detecting tool consists of a flat surface having a center which is aligned with a center of an imaginary sphere which is partially defined by the part-spherical surface.

In the method according to the above mode (7), the detecting tool has a part-spherical surface as the contact surface for contact with the sucking end of the suction nozzle when the detecting tool is held by suction by the suction nozzle. As described above, this detecting tool can be held by suction by the suction nozzle with high stability even when the actual axis of the suction nozzle is misaligned with the nominal axis when or before the detecting tool is sucked onto the sucking end face of the suction nozzle. The method according to the above mode (8) uses the detecting tool in the form of a hemisphere described before in detail, or a substantial hemisphere having an annular brim which extends from the imaged surface in the form of a flat surface of the hemisphere, as described below with respect to a preferred embodiment of the invention. The detecting tool used in the method according to the above mode (7) or (8) permits easy and accurate detection of the center position of the sucking end of the suction nozzle, for the reason already described above.

(9) A method according to any one of the above modes (1)-(3), wherein the step of preparing a detecting tool comprises preparing a detecting tool which is positioned relative to the suction nozzle such that the contact surface is in contact with at least one of an inner circumferential surface and an outer circumferential surface of a sucking end portion of the suction nozzle which has the sucking end.

In the method according to the above mode (9), the detecting tool can be accurately positioned relative to the center of the outer inner circumferential surface and/or the center of the inner circumferential surface of the suction nozzle. Example of the detecting tool used in the above mode (9) include a detecting tool having a center shaft portion to be fitted in a center bore of the sucking end portion of the suction nozzle, and a detecting tool having a center recess in which the sucking end portion of the suction nozzle is to be fitted.

(10) A method according to any one of the above modes (1)-(9), wherein the object to be held by suction by the suction nozzle is an electric component to be mounted on a circuit substrate, and the suction nozzle is a part of a component-mounting device operable to mount the electric component on the circuit substrate.

In an electric-component mounting system having a suction nozzle arranged to hold an electric component by suction, it is desirable to accurate detect the position of the sucking end of the suction nozzle, for assuring high accuracy of positioning of the electric component mounted on a circuit substrate, as described above. In this respect, the method according to the invention which permits accurate detecting of the sucking-end position of the suction nozzle is advantageous to enable the electric-component mounting system to mount the electric component with high positioning accuracy. Where the electric-component mounting system is provided with a component imaging device for imaging the electric component, this component imaging device may be utilized to facilitate the detection of the sucking-end position of the suction nozzle.

The application of the present method is not limited to the detection of the sucking-end position of the suction nozzle that is a component of the electric-component mounting system. For example, the present method is equally applicable to suction nozzles used for various purposes, such as a suction nozzle that is a part of a component-carrier head in an assembling system arranged to assemble various machines, instruments, devices, etc., wherein the component-carrier head is operable to hold a component of a machine, for instance, and move the component to a predetermined position for installation of the component.

(11) A detecting tool for detecting a position of a sucking end of a suction nozzle arranged to hold an object by suction at the sucking end under a negative pressure, comprising:

a first portion having a contact surface for contact with the sucking end of the suction nozzle when the detecting tool is held by suction by the suction nozzle: and

a second portion having an imaged surfaced which is opposite to the contact surface and which is imaged when the detecting tool is held by suction by the suction nozzle such that a center of an image of the imaged surface taken in an axial direction of the suction nozzle lies on an axis of the suction nozzle.

The detecting tool according to the above mode (11) is used in the method according to the above mode (1), and may incorporate any one of the technical features according to the above modes (2)-(9).

(12) A detection assisting kit for detecting a position of a sucking end of a suction nozzle arranged to hold an object by suction at the sucking end under a negative pressure, comprising:

at least one detecting tool each of which has (a) a contact surface for contact with the sucking end of the suction nozzle when the detecting tool is held by suction by the suction nozzle, and (b) an imaged surface which is opposite to the contact surface and which is imaged when the detecting tool is held by suction by the suction nozzle such that a center of an image of the imaged surface taken in an axial direction of the suction nozzle lies on an axis of the suction nozzle; and

a tool container accommodating the at least one detecting tool and including tool-positioning means for locating one of the at least one detecting tool at a predetermined tool-pickup position at which the one detecting tool is picked up by suction by the suction nozzle.

The detecting assisting kit according to the above mode (12) comprises at least one detecting tool each constructed as described above, and a tool container accommodating the at least one detecting tool. The tool container includes tool-positioning means for locating one of the at least one detecting tool at the predetermined tool-pickup position at which this one detecting tool is picked up by suction by the suction nozzle. For the suction nozzle to pick up the detecting tool, the suction nozzle is moved to the pick-up position. Where the present detection assisting kit is used in an electric-component mounting system, the position of the sucking end of the suction nozzle provided in the system can be automatically detected according to a suitable control program. The present detection assisting kit is particularly useful when it is used for automatic detection of the sucking-end position of the suction nozzle. The tool container may have only one tool-pickup position. In this case, the tool container may be arranged to accommodate a plurality of detecting tools such that the detecting tools are sequentially moved one after another to the tool-pickup position, so that each of the detecting tools is pickup by suction by the suction nozzle at this tool-pickup position. Alternatively, the tool container may have two or more tool-pickup positions, or tool-pickup positions corresponding to the respective detecting tools accommodated in the tool container. In the latter case, the detecting tools are sequentially picked up at the respective tool-pickup positions.

(13) A detection assisting kit according to the above mode (12), wherein each of the at least one detecting tool is a spherical tool, and the tool-positioning means includes a bottom wall of the tool container, the bottom wall including an inclined portion a surface of which is inclined to permit the spherical tool to roll down thereon toward the predetermined tool-pickup position at which the surface has a lowest level.

In the detection assisting kit according to the above mode (13) wherein a portion of the bottom wall of the tool container is inclined downwards toward the tool-pickup position, the spherical tool easily rolls down by gravity on the surface of the inclined portion of the bottom wall until the spherical tool reaches the tool-pickup position at which the inclined surface has the lowest level. For example, the bottom wall of the tool container is inclined in a surface area having the lowest position, such that the surface area is inclined downwards toward the lowest position. The tool-positioning means provided according to the above mode (13) may include a bottom wall of the tool container which is merely recessed to provide the lowest position at the tool-pickup position. In this case, after the detection of the sucking-end position of the suction nozzle on the basis of the image of the spherical detecting tool, the suction nozzle carrying the spherical detecting tool is moved to a position near the recess, and releases the tool at this position, so that the spherical tool rolls down to the lowest position in the recess, whereby the spherical tool thus located at the lowest tool-pickup position can be picked up again by the suction nozzle.

(14) A detection assisting kit according to the above mode (13), wherein the tool container includes (i) a return portion having a predetermined tool-return position which is spaced from the predetermined tool-pickup position and at which the spherical tool is returned by the suction nozzle into the tool container, and (ii) a pickup portion having the predetermined tool-pickup position, and wherein the inclined portion of the bottom wall is continuously inclined downwards from the tool-return position to the tool-pickup position.

Where the tool container accommodates a large number of spherical tools and arranged such that these spherical tools are sequentially pickup up by the suction nozzle at the lowest tool-pickup position, the spherical tools may be superposed on each other near the tool-pickup position. In view of this drawback, the detection assisting kit according to the above mode (14) is arranged such that the tool container includes a return portion having a tool-return position spaced from the tool-pickup position, and the inclined portion of the bottom wall is continuously inclined downwards from the tool-return position to the tool-pickup position, so that the spherical tools roll down on the surface of the inclined bottom wall portion toward the lowest tool-pickup position. This arrangement is effective to prevent the spherical tools from being superposed on each other near the tool-pickup position. In the present arrangement, however, the spherical tool located at the tool-pickup position may be pushed off the tool-pickup position by the other spherical tools near the tool-pickup position. In this respect, the tool container is preferably provided with movement-preventing means for preventing the spherical tool at the tool-pickup position from being moved from the tool-pickup position by the other spherical tools. Where the inclined bottom wall portion is inclined so that the spherical tools generally flow in only one direction toward the tool-pickup position, the movement-preventing means may include a side wall formed adjacent to and downstream of the tool-pickup position as seen in the direction of flow of the spherical tools, so as to prevent the spherical tool at the tool-pickup position from being moved downwards off the tool-pickup position. Where the inclined bottom wall portion is inclined such that the spherical tools tend to gather together near the tool-pickup position, preventing one of the spherical tools from being located at the tool-pickup position, the tool container is preferably provided with container-vibrating means such as a vibrator for vibrating or oscillating the tool container, or any other means for facilitating the movement of the spherical tools one after another to the tool-pickup position.

Each of the at least one detecting tool used in the detection assisting kit according to any one of the above modes (12)-(14) may incorporate any one of the technical features according to the above modes (2)-(9).

### BRIEF DESCRIPTION OF THE DRAWINGS

The above and other objects, features, advantages and technical and industrial significance of the present invention will be better understood by reading the following detailed description of preferred embodiments of the invention, when considered in connection with the accompanying drawings, in which:

FIG. 1 is a plan schematically showing an overall arrangement of an electronic-component mounting system;

FIG. 2 is a side elevational view of the electronic-component mounting system of FIG. 1;

FIG. 3 is a back elevational view partly in cross section of a component-mounting unit of the electronic-component mounting system;

FIG. 4 is a perspective view of a component imaging device provided on the electronic-component mounting system;

FIG. 5 is a block diagram schematically illustrating a control device of the electronic-component mounting system;

FIGS. 6A and 6B are views schematically showing images of an electronic component as held by a suction nozzle;

FIG. 7 is a view showing an image of the electronic component as held by the suction nozzle accurately aligned with an axis of a component-mounting head, where the electronic component has a positioning error with respect to the suction nozzle;

FIG. 8 is a view schematically showing the suction nozzle whose sucking end is misaligned with the axis of the component-mounting head;

FIG. 9 is a view schematically showing the axis of the component-mounting head misaligned with an optical axis of a component imaging device;

FIG. 10 is a view a front image of the sucking-end face of the suction nozzle;

FIG. 11A is a front elevational view showing a detecting tool held by suction on the sucking end of the suction nozzle, while FIG. 11B is a view showing an image of the detecting tool taken by the component imaging device in the state of FIG. 11A;

FIG. 12 is a view schematically showing a method of detecting amounts of deviation or misalignment of the sucking end of the suction nozzle with respect to the nominal position of its axis, by using the detecting tool in the form of a ball, where the optical axis of the component imaging device and the axis of the component-mounting head are aligned with each other;

FIG. 13 is a view schematically showing a method of detecting amounts of deviation or misalignment of the sucking end of the suction nozzle with respect to the nominal position of its axis, by using the detecting tool in the form of a ball, where the optical axis of the component imaging device and the axis of the component-mounting head are misaligned with each other;

FIG. 14 is a perspective view showing a detection assisting kit which is provided on the electronic-component mounting system and which is used to detect the sucking-end position of the suction nozzle;

FIG. 15 is a view showing the detecting tool immediately before the detecting tool is sucked onto the sucking end face of the suction nozzle, where the sucking end of the suction nozzle is misaligned with the nominal axis;

FIGS. 16A and 16B are views showing one modified form of a tool container that can be used in the detection assisting kit;

FIGS. 17A and 17B are views showing another modified form of the tool container that can be used in the detection assisting kit;

FIGS. 18A, 18B and 18C are views showing modified forms of the detecting tool as held on the suction nozzle; and

FIGS. 19A and 19B are views showing further modified forms of the detecting tool as held on the suction nozzle.

### DETAILED DESCRIPTION OF THE PREFERRED EMBODIMENTS

There will be described the preferred embodiments of this invention as applied to a suction nozzle provided on an electronic-component mounting system. For easier understanding of the embodiments, an arrangement of the electronic-component mounting system will first be described, and then a method of detecting the sucking-end position of the suction nozzle, and the detecting tool and detection assisting kit used in the method will then be described.

<Electronic-Component mounting system>

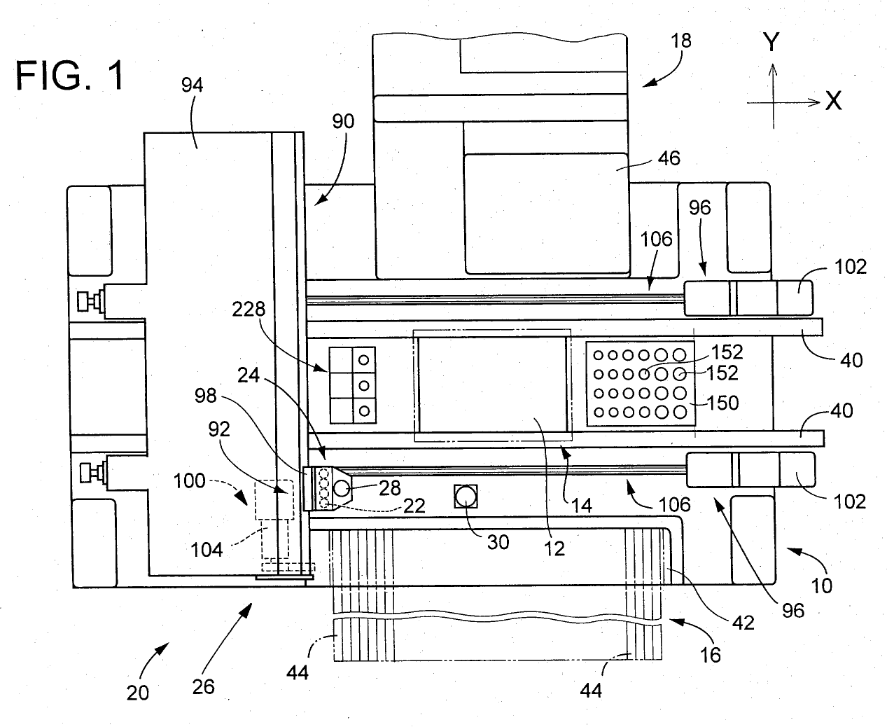

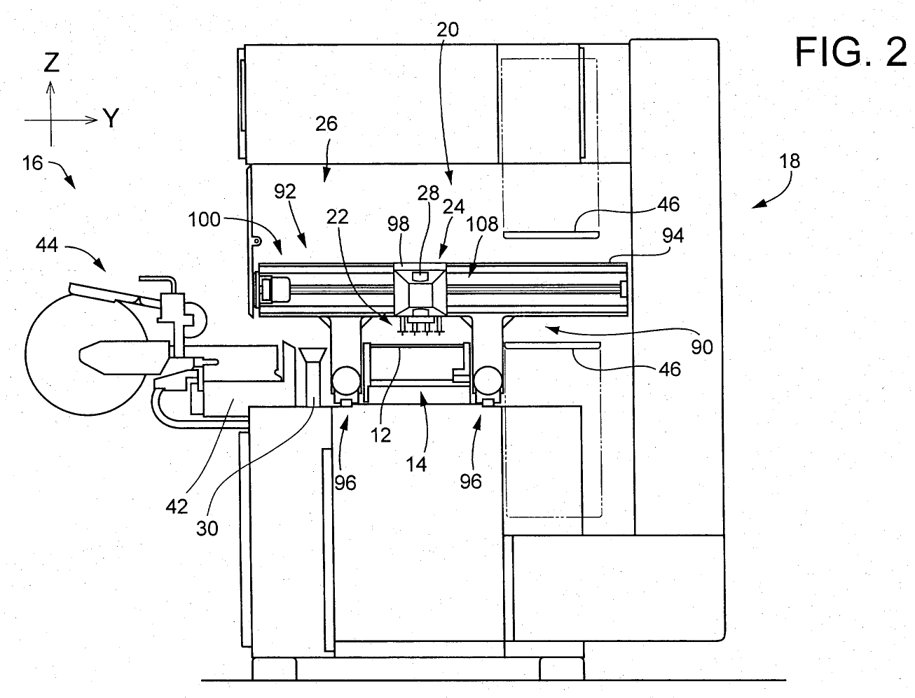

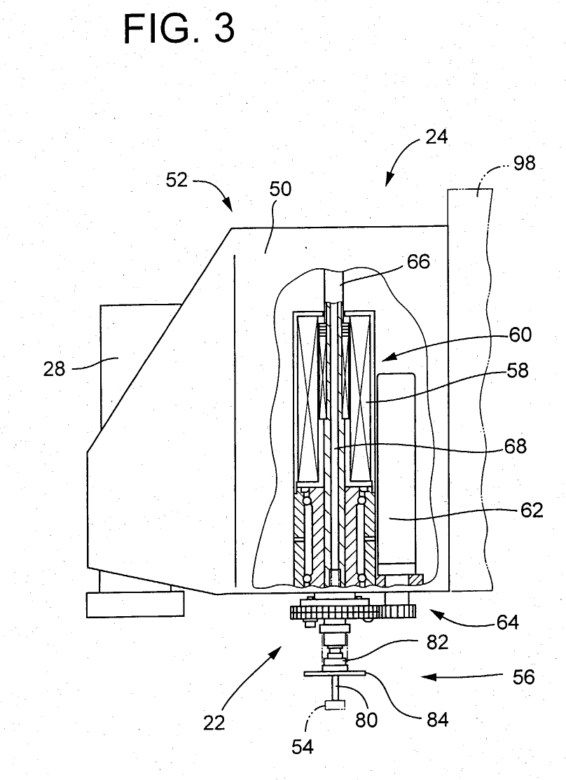

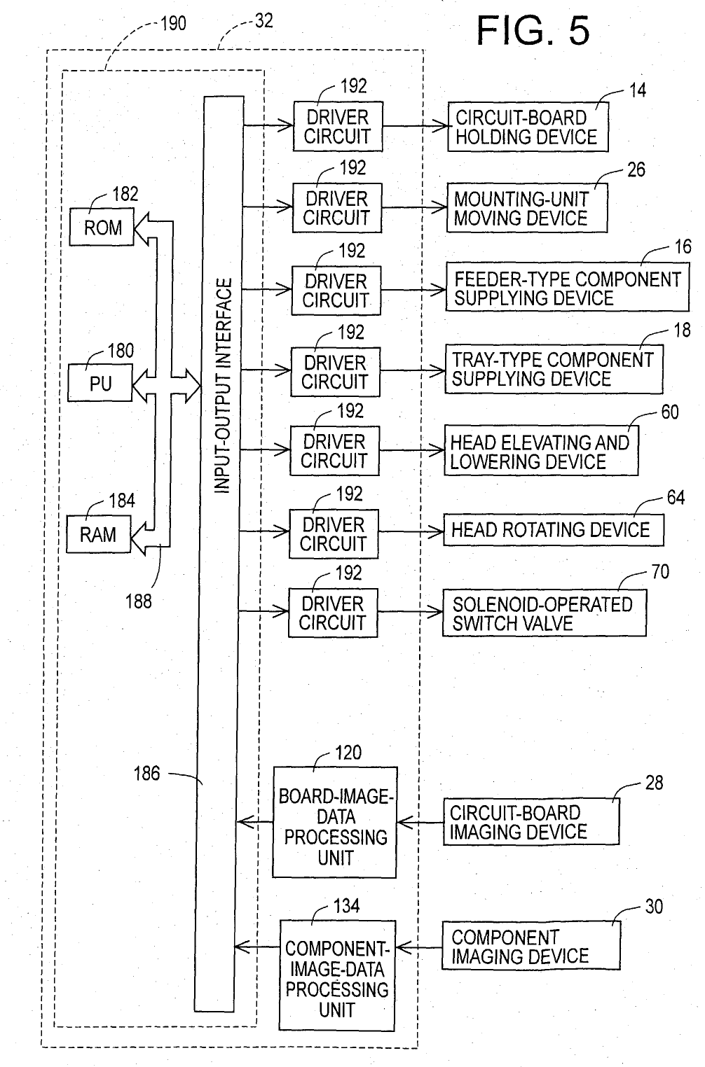

Referring first to the plan view of FIG. 1 and the side elevational view of FIG. 2, there is schematically shown an overall arrangement of the electric-component mounting system, which includes: a machine base 10 serving as a main body of the system; a circuit-board holding device 14 disposed on the machine base and arranged to hold a circuit board 12; a feeder type component-supplying device 16 disposed on a front side (lower side as seen in FIG. 1) of the circuit-board holding device 14; a tray type component-supplying device 18 disposed on a rear side (upper side as seen in FIG. 1) of the circuit-board holding device 14; and an electric-component mounting device in the form of a component-mounting device 20 arranged to receive electronic components 54 (FIG. 3) from a component-supplying portion of the system constituted by the two component-supplying devices 16, 18, and mount the electronic components 54 on the circuit board 12 held by the circuit-board holding device 14. The component-mounting device 20 has a component-mounting unit 24 including a plurality of component-mounting heads 22, more precisely, four component-mounting heads 22, and a mounting-unit moving device 26 arranged to move the component-mounting unit 24 between the component-supplying portion and the circuit board 12 held by the circuit-board holding device 14. The present electronic-component mounting system further includes a circuit-board imaging device 28 attached to the component-mounting unit 24 and operable to take an image of the component-mounting surface of the circuit board 12, a component imaging device 30 operable to take an image of the electronic component 54 as held by each component-mounting head 22, and a control device 32 (FIG. 5) provided to control the above-indicated various devices in a centralized or coordinated fashion.

The circuit-board holding device 14 is arranged to hold the circuit board 12 transferred by a circuit-board conveyor 40, such that the circuit board 12 is located at a position substantially aligned with a nominal component-mounting position in which the electronic components 54 are mounted on the board 12. The feeder type component-supplying device 16 includes a component supply table 42, and a plurality of tape feeders 44 mounted on the component supply table 42 such that the tape feeders 44 are arranged in an X-axis direction (right and left direction as seen in FIG. 1). Each tape feeder 44 is arranged to feed a carrier tape accommodating a multiplicity of electronic components 54 of the same kind, such that the electronic components 54 are fed one after another to a predetermined component-supply position. The tray type component-supplying device 18 includes a plurality of trays 46 which are superposed on each other in a stack and each of which accommodates a plurality of electronic components 54. The trays 46 are vertically moved to a component-supply position at which the component-mounting unit 24 can receive each electronic component 54 from the selected tray 46.

Referring next to the back elevational view of FIG. 3, there is shown the component-mounting unit 24 partly in cross section. The component-mounting unit 24 includes: a main body 52 integral with a housing 50; the above-indicated four component-mounting heads 22 each carrying a suction nozzle 56 and supported by the component-mounting unit 52 such that each component-mounting head 22 is rotatable and vertically movable; four head elevating and lowering devices 60 each including a drive source in the form of an electric motor 58 (linear servomotor) and operable to vertically move the corresponding one of the four component-mounting heads 22; and four head rotating devices 64 each including a drive source in the form of an electric motor 62 (linear servomotor) and operable to rotate the corresponding component-mounting head 22 about its axis. he suction nozzle 56 is operable to hold the electric component 54 at its sucking end (lower end). Each component-mounting head 22 is vertically moved to receive the electronic component 54 when the head 22 is located at a component-receiving position, and mount the electronic component 54 onto the component-mounting surface of the circuit board 12 when the head 22 is located at the predetermined component-mounting position. The component-mounting head 22 is rotated about its axis by the head rotating device 64, for some purposes, for instance, to eliminate an angular positioning error of the electronic component 54 as held by the suction nozzle 56.

Each of the component-mounting heads 22 includes a hollow center shaft 66 having a center bore 68 which functions as an air passage. The suction nozzle 56 is removably attached to the lower end portion of the center shaft 66 such that the suction nozzle 56 is held in communication with the center bore 68. In each component-mounting head 22, the center bore 68 is selectively communicated at its upper end portion (not shown) with a negative-pressure source, a positive-pressure source and the atmosphere, through a solenoid-operated switch valve 70 shown in FIG. 5. When the center bore 68 is communicated with the negative-pressure source, an object to be held, that is, the electronic component 54 is drawn onto the sucking or lower end face of the suction nozzle 56, with a suction force generated by the negative pressure. When the center bore 68 is communicated with the atmospheric or the positive-pressure source, the electronic component 54 is released from the sucking end face of the suction nozzle 56.

Each of the suction nozzles 56 of the four component-mounting heads 22 includes a cylindrical nozzle portion 80, a mounting portion 82, and a background portion 84 in the form of a circular plate interposed between the nozzle portion 80 and the mounting portion 82. The nozzle portion 80 has the sucking end at which the electronic component 54 is held by suction. The mounting portion 82 is removably attached to the lower end portion of the center shaft 66. The background portion 84 has a lower surface which serves as a background in which an image of the electronic component 54 held by the nozzle portion 80 is taken by the component imaging device 30. Thus, the background portion 84 facilitates detection of the position of the electronic component 54 as held by the nozzle portion 80. The background portion 84 will be described in greater detail.

The mounting-unit moving device 26 is an XY robot type moving device including an X-axis robot device 90 and a Y-axis robot device 92. The X-axis robot device 90 is disposed on the machine base 10, and includes an X-axis slide 94 and an X-axis slide positioning device 96 operable to position the X-axis slide 94 in the X-axis direction. The Y-axis robot device 92 is mounted on the X-axis slide 94, and includes a Y-axis slide 98 and a Y-axis slide positioning device 100 operable to position the Y-axis slide 98 in a Y-axis direction perpendicular to the X-axis direction. The X-axis robot device 90 and the Y-axis robot device 92 include respective drive sources in the form of electric motors 102, 104 (servomotors), and respective ballscrew mechanisms 106, 108. The component-mounting unit 24 is fixedly disposed on the Y-axis slide 98. The mounting-unit moving device 26 is operated according to a component-mounting program, to move the component-mounting unit 24 for moving each component-mounting head 22 to the predetermined component-receiving and component-mounting positions.

The circuit-board imaging device 28 is attached to the component-mounting unit 24. The circuit-board imaging device 28 is provided with an imaging device in the form of a substrate imaging camera (CCD camera), and other devices such as a light source. The circuit-board imaging device 28 is moved by the mounting-unit moving device 26. That is, the mounting-unit moving device 26 also functions as a device for moving the circuit-board imaging device 28. The circuit-board imaging device 28 is provided to take images of fiducial marks provided on the circuit board 12 held by the circuit-board holding device 14 on which the electronic components 54 are to be mounted. Image data representative of the images of the fiducial marks taken by the circuit-board imaging device 28 are processed by a board-image-data processing device 120 (FIG. 5), to detect positioning errors of the circuit board 12 as held by the circuit-board holding device 14. The detected positioning errors of the circuit board 12 are utilized when the electronic components 54 are mounted on the circuit board 12.

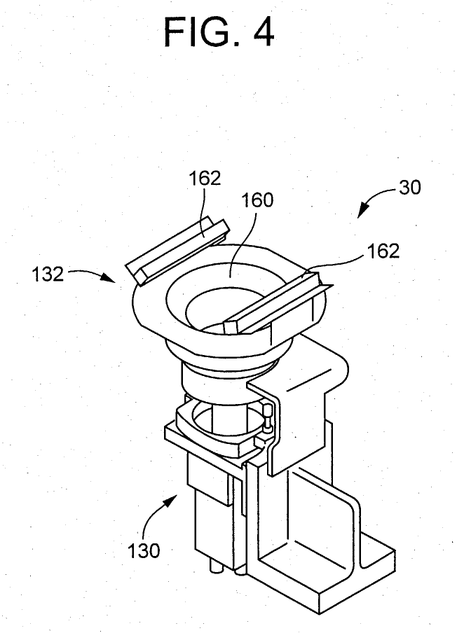

The component imaging device 30 is disposed on the machine base 10, and located between the feeder type component-supplying device 16 and the circuit-board holding device 14. As shown in the perspective view of FIG. 4, this component imaging device 30 is provided with an imaging device in the form of a component imaging camera (CCD camera), and an light-source portion 132 including a light source. After the component-mounting heads 22 have received the electronic components 54 from the component-supply portion, the component-mounting unit 24 is moved toward the circuit board 12. During this movement of the component-mounting unit 24, the component-mounting unit 24 is stopped such that the component-mounting heads 22 are located right above the component imaging device 30, so that the electronic components 54 are imaged by the component imaging device 30 in the upward direction. Image data representative of the images of the electronic components 54 are processed by a component-image-data processing unit 134 (FIG. 5), to detect positioning errors of the electronic components 54 as held by the suction nozzles 56. The detected positioning errors are utilized when the electronic components 54 are mounted on the circuit board 12.

The present electronic-component mounting system further includes a nozzle accommodating device 150 disposed adjacent to the circuit-board holding device 14 in the X-axis direction, namely, on the right side of the circuit-board holding device 14. This nozzle accommodating device 150 has a plurality of nozzle accommodating portions 152 which accommodate respective suction nozzles 56 of different kinds. In FIG. 1, the suction nozzles 56 accommodated in the nozzle accommodating portions 152 are not shown. The four component-mounting heads 22 use the respective suction nozzles 56 of the kinds corresponding to the kinds of the electronic components 54 to be held. When the suction nozzle 56 for a given component-mounting head 22 is changed from one kind to another, the component-mounting unit 24 is first moved so that the component-mounting head 22 in question is located right above the nozzle accommodating portion 152 corresponding to the suction nozzle 56 presently mounted on the component-mounting head 22 in question. In this position, the component-mounting head 22 is lowered to return the present suction nozzle 56 in the nozzle accommodating portion 152, and is then elevated. The component-mounting unit 24 is subsequently moved so that the component-mounting head 22 is located right above the nozzle accommodating portion 152 in which the new suction nozzle 56 of the kind to be newly mounted. In this position, the component-mounting head 22 is lowered to receive the new suction nozzle 56 and then elevated. An operation to change the suction nozzle 56 mounted on each component-mounting head 22 may be automatically performed according to the component-mounting program.

The component imaging device 30 may take either a front image or a silhouette image of each electronic component 54, depending upon the kind of the electronic component 54. As shown in FIG. 4, the light-source portion 132 of the component imaging device 30 has a visible-light lamp 160 in the form of a ring operable to generate a visible light, and a pair of ultraviolet-light lamps 162 operable to generate a ultraviolet light. The visible-light lamp 160 is activated to take the front image of the electronic component 54, and the ultraviolet-light lamps 162 are activated to take the silhouette image of the electronic component 54. The kind of the suction nozzle 56 is also changed depending upon whether the front image or the silhouette image of the electronic component 54 is to be taken. Namely, when the front image is to be taken, the background portion 84 of the suction nozzle 56 must have a lower surface which absorbs the visible light, that is, a relatively black surface. When the silhouette image is to be taken, the background portion 84 of the suction nozzle 56 must be a fluorescent plate which is capable of generating a fluorescent light when the ultraviolet light is incident upon the fluorescent plate. The component imaging device 30 operates to image the electronic component 54 with the visible light, and either the visible-light lamp 160 or the ultraviolet-light lamps 162 cooperates or cooperate with the background portion 84 of the suction nozzle 56, to selectively take either the front image or the silhouette image of the electronic component 54. The imaging operation of the component imaging device 30 to take the image of the electronic component 54 will be described in greater detail.

The above-described various devices of the present electronic-component mounting system are controlled by the control device 32. The block diagram of FIG. 5 shows the control device 32 and other elements of the system which relate to the present invention. The control device 32 is principally constituted by a computer 190 incorporating a PU (processing unit) 180, a ROM (read-only memory) 182, a RAM (random-access memory) 184, an input-output interface 186, and a bus 188 which interconnect the PU, 180, ROM 182, RAM 184 and interface 186 to each other. To the input-output interface 186, there are connected through respective driver circuits 192 the circuit-board holding device 14, mounting-unit moving device 26, feeder type component-supplying device 16, tray type component-supplying device 18, head elevating and lowering device 60, head rotating device 64 and solenoid-operated switch valve 70. To the input-output interface 186, there are also connected the circuit-board imaging device 28 and the component imaging device 20 through the board-image-data processing unit 120 and the component-image-data processing unit 134, respectively, to detect the positioning errors of the circuit boards 12 relative to the circuit-board holding device 14, and the positioning errors of the electronic components 54 relative to the suction nozzle 56, as described above. The ROM 182 stores control programs such as a basic control program for operating the present electronic-component mounting system, while the RAM 184 stores component-mounting programs for the respective circuit boards 12, and the above-indicated positioning errors of the electronic components 54 and the positioning errors of the circuit boards 12.

An operation of the present electronic-component mounting system to mount the electronic components 54 on the circuit board 12 will be briefly described. Initially, the circuit board 12 transferred by the circuit-board conveyor 40 is held by the circuit-board holding device 14, at a position substantially aligned with the nominal component-mounting position. The circuit-board imaging device 28 carried by the component-mounting unit 24 is successively moved to two positions right above the respective two fiducial marks located at respective corners of the component-mounting surface of the circuit board 12. The images of these two fiducial marks are successively taken by the thus moved circuit-board imaging device 28. The thus obtained image data are processed by the board-image-data processing unit 120, to obtain the positioning errors of the circuit board 12 as held by the circuit-board holding device 14. The obtained positioning errors of the circuit board 12 are stored in the RAM 184, and these positioning errors are eliminated when the electronic components 54 are subsequently mounted on the circuit board 12, so that the electronic components 54 can be mounted on the circuit board 12 at respective predetermined component-mounting spots with high positioning accuracy.

The component-mounting unit 24 is moved so that the component-mounting heads 22 are located at the component-supply position at which the electronic components 54 are supplied by the feeder type component-supplying device 16 or the tray type component-supplying device 18. In this component-supply position, each of the component-mounting heads 22 is lowered and communicated with the negative-pressure source, to hold the corresponding electronic component 54 at the sucking end of the nozzle portion 80 of the suction nozzle 56. Usually, the four component-mounting heads 22 receive the respective electronic components 54 one after another.

Then, the component-mounting unit 24 is moved to move each component-mounting head 22 at the position right above the component imaging device 30. The component imaging device 30 takes an image of the electronic component 64 in the upward direction parallel to the axial direction of the component-mounting head 22. The thus obtained image data are processed by the component-image-data processing device 134 to obtain the positioning errors of the electronic component 54 relative to the axis of the component-mounting head 22. The positioning errors of the electronic components 54 as held by the four component-mounting heads 22 are successively obtained, and stored in the RAM 184. These positioning errors are eliminated when the electronic components 54 are subsequently mounted on the circuit board 12, so that the electronic components 54 can be mounted on the circuit board 12 at the respective predetermined component-mounting spots with high positioning accuracy. The operations to take the images of the electronic components 54 and obtain their positioning errors will be described in greater detail.

Subsequently, the component-mounting unit 24 is moved to move the component-mounting heads 22 to positions above the circuit board 12, which position correspond to the respective component-mounting spots of the electronic components 54. However, the positions to which the component-mounting heads 22 are moved are adjusted to eliminate the positioning errors of the circuit substrate 12 and the positioning errors of the electronic components 54, in the X-axis and Y-axis directions. Further, each of the component-mounting heads 22 is rotated about its axis, so as to establish a desired angular mounting position of the electronic component 54, and so as to eliminate the angular positioning error of the circuit substrate 12 and the angular positioning error of the electronic component 54 in the XY plane (perpendicular to the X-axis and Y-axis directions). Each component-mounting head 22 thus positioned is lowered and communicated with the positive-pressure source, to mount the electronic component 54 onto the component-mounting surface of the circuit substrate 12. The component-mounting unit 24 is moved to successively position the four component-mounting heads 22 for mounting the respective four electronic components 54 on the circuit board 12 one after another. Thus, one cycle of component-mounting cycle is completed. This cycle of component-mounting cycle is repeatedly implemented to mount all of the desired electronic components 54 on the circuit substrate 12. After completion of the operation to mount the electronic components 54 on the circuit board 12, the circuit-board holding device 14 releases the circuit board 12, and the circuit-board conveyor 40 is activated to unload the circuit substrate 12 from the present electronic-component mounting system.

<Relationship Between the Imaging of the Electronic Component 54 and the Sucking-End position of the Suction Nozzle 56>

As described above, the present electronic-component mounting system is arranged to obtain the positioning errors of the electronic components 54 as held by the suction nozzles 56, and effect compensation for eliminating the positioning errors, to assure mounting of the electronic components 54 on the circuit board 12, with high positioning accuracy. Accordingly, the accurate mounting of the electronic components 54 requires accurate detection of the positioning errors of the electronic components 54 as held by the suction nozzles 56.

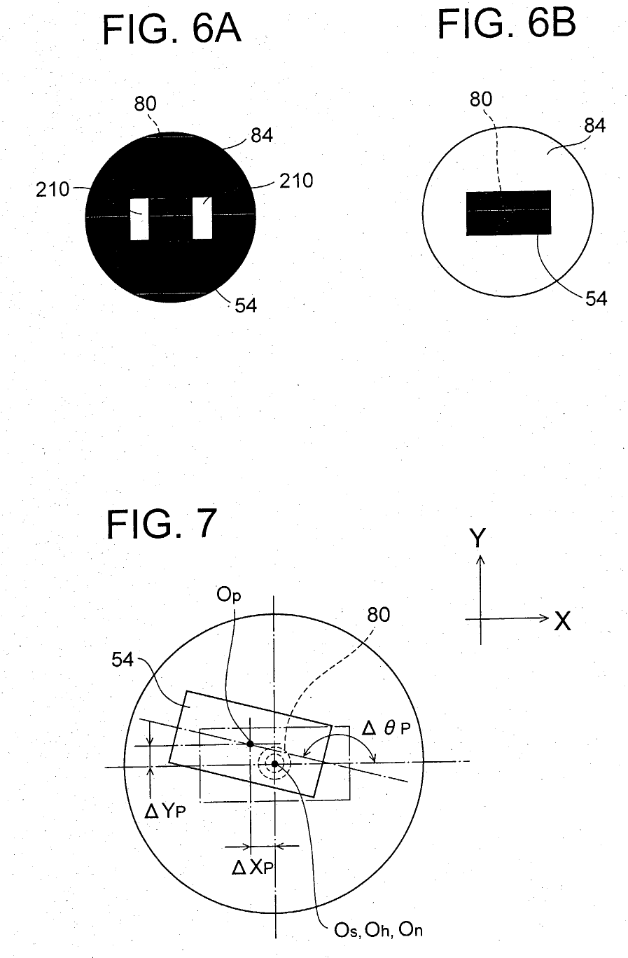

Referring next to FIGS. 6A and 6B, there are schematically shown images of the electronic components 54 taken by the component imaging device 30. Namely, FIG. 6A shows the front image of the electronic component 54, while FIG. 6B shows the silhouette image of the electronic component 54. The outermost circle indicates a field of vision or image area of the component imaging device 30, which is defined by the periphery of the lower surface of the background portion 84 of the suction nozzle 56. In the case of the front image, the background portion 84 has the relatively black lower surface, so that two metallic terminal portions 210 of the electronic component 54 are imaged with a high degree of contrast with respect to the background. In this case, the horizontal center-position errors of the electronic component 54 in the X-axis and Y-axis directions and the angular positioning error of the electronic component 54 (in a θ-axis direction) in the XY plane are detected on the basis of profiles of the two metallic terminal portions 210. In the case of the silhouette image, on the other hand, the background portion 84 has the lower surface coated with a fluorescent layer, which generates a fluorescent light upon incidence of a ultraviolet light on the fluorescent layer, so that a relative dark image of the entirety of the electronic component 54 is obtained with a high degree of contract with respect to the relatively light background. In this case, the horizontal center-position errors of the electronic component 54 in the X-axis and Y-axis directions and the angular positioning error of the electronic component 54 in the θ-axis direction are detected on the basis of the profile of the electronic component 54 as a whole. The front image or the silhouette image is selected depending upon the kind of the electronic component 54.

The present electronic-component mounting system is designed such that the axis of the suction nozzle 56, more precisely, the axis of the nozzle portion 80 of the suction nozzle 56 is aligned with the axis of the corresponding component-mounting head 22. In other words, the nominal position of the axis of the suction nozzle 56 is aligned with the axis (axis of rotation) of the component-mounting head 22. Further, the component-mounting unit 24 is moved such that the axis of the component-mounting head 22 is aligned with the optical axis of the component imaging device 30. FIG. 7 shows an image of the electronic component 54 as held by the suction nozzle 56 accurately aligned with the axis of the component-mounting head 22 and the optical axis of the component imaging device 30, where the electronic component 54 has a positioning error with respect to the suction nozzle 56. In this condition, the center of the field of vision of the imaging device 30 lies on the optical axis Oₛ of the imaging device 30 (more precisely, its component imaging camera 130), which is aligned with the axis Oₕ of the component-mounting head 22 and the axis Oₙ of the suction nozzle 56 (more precisely, its nozzle portion 80). In the case of FIG. 7, the electronic component 54 has a center Oₚ which deviates from the axes Oₛ, Oₕ and Oₙ, and is inclined with respect to the X axis and Y axis in the XY plane. Namely, the electronic component 54 as held by the suction nozzle 56 has an X-axis center-position error ΔXp and a Y-axis center-position error ΔYp with respect to the axis Oₙ of the suction nozzle 56, and an angular positioning error Δθp in the θ-axis direction. This electronic component 54 can be mounted on the circuit board 12, with high positioning accuracy, by eliminating those center-position errors and angular positioning error.

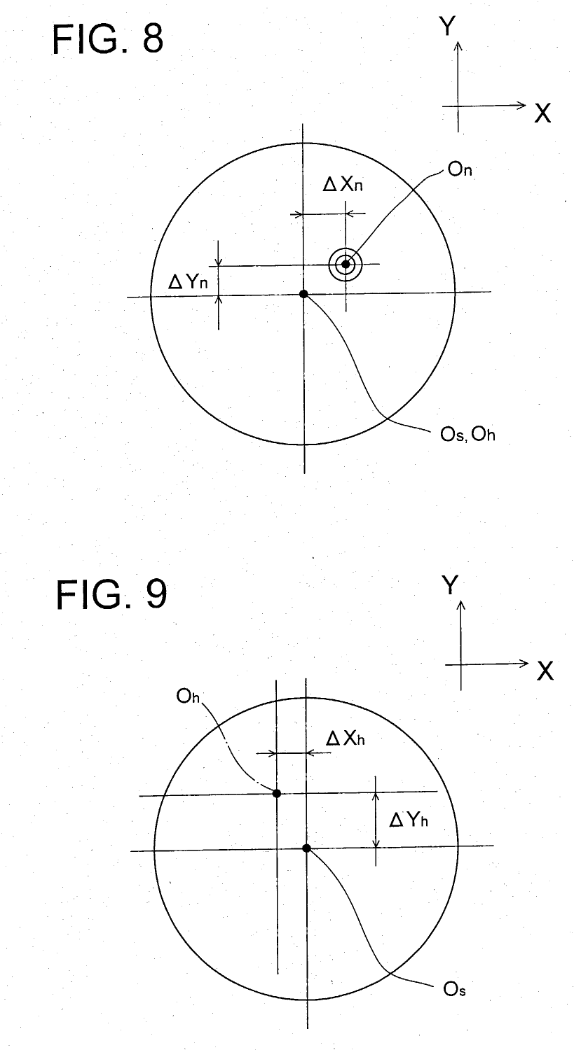

However, the sucking-end position of the suction nozzle 56, that is, the sucking end position of the nozzle portion 80 may deviate from its nominal position, due to bending of the nozzle portion 80 or deformation of the mounting portion 82. FIG. 8 schematically shows a deviation of the sucking-end position of the suction nozzle 56 with respect to the axes Oₛ and Oₕ of the component imaging device 30 and the component-mounting head 22. In the state of FIG. 8, the component-mounting head 22 is placed in its reference angular position. In this position, the center of the sucking end of the suction nozzle 56 is offset from the axes Oₛ, Oₕ by a distance ΔXn in the X-axis direction and by a distance ΔYn in the Y-axis direction. If the suction nozzle 56 in this state receives the electronic component 54 at the component-supplying device 16, 18, for example, the sucking-end face of the suction nozzle 56 cannot hold the electronic component 54 by suction such that the center of the electronic component 54 is sufficiently aligned with the center of the sucking end face of the suction nozzle 56. Namely, the center of the sucking end face of the suction nozzle 56 positioned by a movement of the component-mounting unit 24 according to a predetermined movement command value to position the component-mounting head 22 at the predetermined component-supply position is offset from the axis Oₕ of the component-mounting head 22, as shown in FIG. 8. In this case, there is a high possibility that the electric component 54 as held by the suction nozzle 56 is misaligned with the axis Oₙ of the suction nozzle 56, inclined in the XY plane, or held at a surface thereof not other than the surface selected for contact with the sucking end face of the suction nozzle 56, and a high possibility that the electronic component 54 falls from the suction nozzle 56, due to an insufficient suction force acting thereon.

The optical axis Oₛ of the component imaging device 30 may be misaligned with the axis Oₕ of the component-mounting head 22. That is, the axis Oₕ of the component-mounting head 22 positioned by a movement of the component-mounting unit 24 according to a predetermined movement command value to move the component-mounting head 22 the nominal position of the component imaging device 30 may be offset from the optical axis Os of the component imaging device 30, as schematically illustrated in FIG. 9 by way of example. In the example of FIG. 9, the axis Oh of the component-mounting head 22 is offset by a distance ΔXh in the X-axis direction and by a distance ΔYh in the Y-axis direction with respect to the optical axis Oₛ of the component imaging device 30. Where this misalignment is caused by a difference between nominal or commanded distances and actual distances of movement of the component-mounting head 22, the suction nozzle 56 carried by the component-mounting head 22 cannot receive and hold the electronic component 54 with high alignment accuracy, and the electronic component 54 cannot be mounted on the circuit board 12 at the predetermined component-mounting spot with high positioning accuracy. Where the misalignment of the axis Oₕ of the component-mounting head 22 with the optical axis Oₛ of the component imaging device 30 is caused by positioning errors of the component imaging device 30, the electronic component 54 cannot be accurately positioned on the circuit board 12. In this respect, the offset distances of the optical axis Oₛ of the component imaging device 30 with respect to the axis Oₕ of the component-mounting head 22 must be obtained.

In summary, to assure accurate mounting of the electronic components 54 on the circuit substrate 12, it is necessary to precisely detect the amounts of deviation or misalignment of the axis Oₕ of the component-mounting head 22 with respect to the optical axis Oₛ of the component imaging device 30 upon imaging of the electronic component 54, and the amounts of deviation or misalignment of the sucking-end position of the suction nozzle 56 with respect to the axis Oₕ of the component-mounting head 22, that is, with respect to the nominal axis of the suction nozzle 56, in the XY plane perpendicular to the nominal axis.

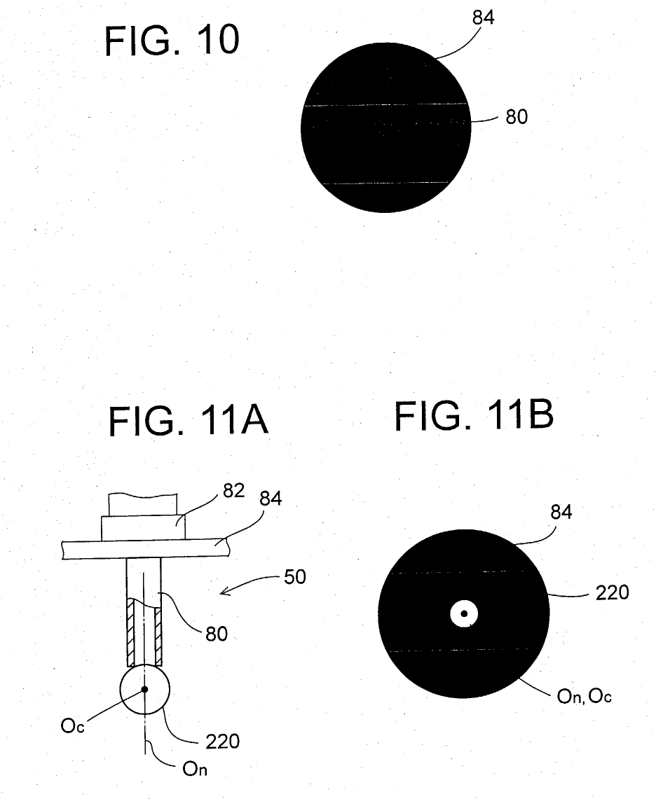

To detect the amounts of the two misalignments indicated above, it is considered to directly take an image of the sucking end face of the suction nozzle 56 while the component-mounting head 22 is placed in its reference angular position. However, the suction nozzle 56 is gradually worn during its repeated use for the component-mounting operation. Accordingly, the image of the sucking end face of the suction nozzle 56 may not be necessarily taken such that an outer profile of the end face is clear enough. Further, the suction nozzle 56 used when the front image of the electronic component 54 is taken is usually colored in its nozzle portion 80 so that the profile of the sucking end face of the nozzle portion 80 is substantially hidden in the relatively black background. This coloring of the nozzle portion 80 is intended to assure clear imaging of the electronic component 54 which is smaller than the diameter of the sucking end face. When the image of the sucking end face of this type of suction nozzle 56 is taken, the profile of the sucking end face as imaged by the component imaging device 30 is undesirably unclear, as indicated in FIG. 10. Thus, it is not always possible to accurately detect the sucking-end position of the suction nozzle 56, by taking the image of the sucking end face of the suction nozzle 56.

<Detection of the sucking-End Position of the Suction Nozzle 56>

In view of the above, the present electronic-component mounting system is arranged to use a detecting tool in the form of a spherical ball for accurate detection of the sucking-end position of the suction nozzle 56. This detecting tool is held by suction on the sucking end face of the suction nozzle 56, and is imaged by the component imaging device 30. The front elevational view of FIG. 11A shows the detecting tool in the form of a ball 220 as held by suction on the sucking end face of the nozzle portion 80 of the suction nozzle 56, while the plan view of FIG. 11B shows an image of the ball 220 taken by the component imaging device 30 while the ball 220 is held by suction on the sucking end face of the nozzle portion 80. The ball 220 used as the detecting tool has a diameter larger than the outside diameter of the nozzle portion 80. As shown in FIG. 11A, the detecting ball 220 held by suction by the suction nozzle 56 has a center O_{c} lying on the axis Oₙ of the nozzle portion 80. As is apparent from FIG. 11B, the sucking end face of the nozzle portion 80 is not seen in the image of the ball 220 taken in the upward direction. The ball 220 has a relatively white surface, so that the image of the ball 220 as taken by the component imaging device 30 has a high contrast with respect to the relatively black lower surface of the background portion 84 of the suction nozzle 84. Accordingly, the profile of the ball 220 can be clearly and easily distinguished from the background, and can be used to accurate detect the center O_{c} of the ball 220. Since the center O_{c} lies on the axis Oₙ of the nozzle portion80 of the suction nozzle 56 as described above, the sucking-end position of the suction nozzle 56 can be easily detected on the basis of the image of the ball 220.

Described in greater detail, the spherical ball 220 as held by suction on the sucking end face of the nozzle portion 80 of the suction nozzle 56 has a contact surface in contact with the sucking end face, and a hemispherical imaged surface which is opposite to the contact surface and which is imaged by the component imaging device 30. Irrespective of a portion of the spherical surface of the ball 220 which functions as the contact surface, the hemispherical imaged surface has a center lying on the axis Oₙ of the nozzle portion 80. Accordingly, the center of the ball 200 determined by the profile of the image taken in the upward direction of projection represents the center of the sucking end face of the suction nozzle 56, irrespective of the portion of the spherical surface of the ball 220 which is in contact with the sucking end face.

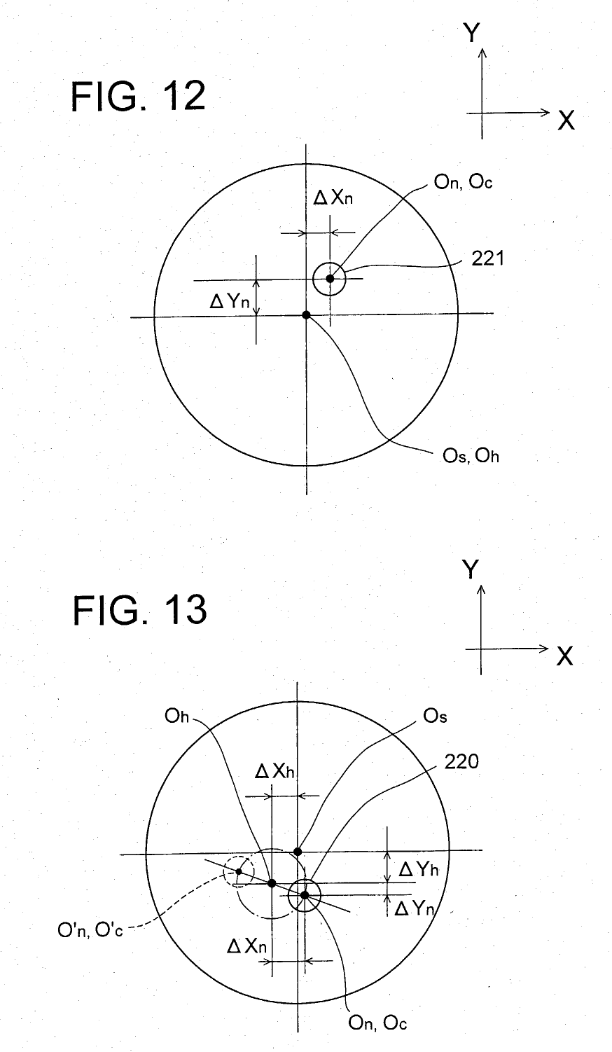

In the present embodiment, the detecting tool in the form of the ball 220 is used to detect the amount of deviation or misalignment of the sucking-end position of the suction nozzle 56 with respect to the nominal position of its axis Oₙ.(hereinafter referred so simply as “nominal axis”) Referring to FIG. 12, there will be described a method of detecting the amount of deviation of the sucking-end position of the suction nozzle 56 with respect to the nominal axis, where the optical axis Oₛ of the component imaging device 30 is accurately aligned with the nominal axis Oₕ of the component-mounting head 22 which is located at the predetermined imaging position (to which the head 22 is moved by a movement of the component-mounting unit 24 according to the nominal movement command value). Initially, the ball 220 used as the detecting tool is held by suction on the sucking end face of the suction nozzle 56 to be detected, and the component-mounting head 22 carrying this suction nozzle 56 is rotated to its predetermined reference angular position. In this condition, the component-mounting unit 24 is moved to move that component-mounting head to the predetermined imaging position right above the component imaging device 30. At this imaging position, the image of the ball 220 is taken by the component imaging device 30. Image data representative of the thus taken image, an example of which is shown in FIG. 12, are processed to detect the amount of misalignment of the axis Oₙ of the sucking end portion of the suction nozzle 56 as represented by the center O_{c} of the ball 220, with respect to the optical axis Oₛ of the component imaging device 30. In the example of FIG. 12, the sucking-end position of the suction nozzle 56 is offset from the optical axis Oₛ (from the axis Oₕ of the head 22) by a distance ΔXn in the X-axis direction and by a distance ΔYn in the Y-axis direction, when the component-mounting head 22 is placed in its reference angular position. In this manner, the deviation of the sucking-end position of the suction nozzle 56 with respect to its nominal axis can be detected by a single operation to take the image of the detecting tool in the form of the ball 220.

Referring next to FIG. 13, there will be described a method of detecting the amount of deviation of the sucking-end position of the suction nozzle 56 with respect to the nominal axis, where the optical axis Oₛ of the component imaging device 30 is misaligned with the nominal axis Oₕ of the component-mounting head 22 located at the predetermined imaging position. Initially, the ball 220 is held by suction on the sucking end face of the suction nozzle 56 to be detected, and the component-mounting head 22 carrying this suction nozzle 56 is rotated to its predetermined reference angular position. In this condition, the component-mounting unit 24 is moved to move that component-mounting head to the predetermined imaging position right above the component imaging device 30. At this imaging position, the image of the ball 220 is taken by the component imaging device 30. Then, the component-mounting head 22 is rotated by 180° from the reference angular position, and the image of the ball 220 is taken again. FIG. 13 shows the thus taken two images of the ball 220 as superposed on each other. The axis Oₕ of the component-mounting head 22 is represented by a midpoint between the axis Oₙ of the nozzle portion 90 of the suction nozzle 56 represented by the center O_{c} of the image of the ball 220 taken at the reference angular position of the head 22, and an axis O′ₙ of the nozzle portion 90 represented by a center O′_{c} of the image of the ball 220 taken at the angular position of the head 22 180° spaced apart from the reference angular position. Therefore, the amount of deviation of the sucking-end position of the suction nozzle 56 with respect to the nominal axis (the axis Oₕ of the component-mounting head 22) is represented by an amount of deviation of the axis Oₙ of the sucking end portion of the suction nozzle 56 in the reference angular position, with respect to the above-indicated midpoint. In the example of FIG. 13, the axis Oₙ of the suction nozzle 56 is offset from the nominal axis by a distance ΔXn1 in the X-axis direction and by a distance ΔYn1 in the Y-axis direction. Further, an amount of deviation of the above-indicated midpoint with respect to the optical axis Oₛ of the component imaging device 30 represents an amount of misalignment of the axis Oₕ of the component-mounting head 22 with respect to the optical axis Oₛ of the component imaging device 30. In the example of FIG. 13, the axis Oₕ of the head 22 is offset from the optical axis O_{c} by a distance ΔXh1 in the X-axis direction and by a distance ΔYh1 in the Y-axis direction. Thus, the amount of deviation of the sucking-end position of the suction nozzle 56 with respect to the axis Oₕ of the component-mounting head 22 and the amount of deviation of the axis Oₕ with respect to the optical axis Oₛ can be detected by taking the two images of the detecting tool in the form of the ball 220 when the component-mounting head 22 is placed in the respective two 180°-spaced-apart angular positions, one of which is the reference angular position.

As described above, the detecting tool in the form of the ball 220 is used to detect the sucking-end position of the suction nozzle 56, the amount of deviation of this sucking-end position with respect to the nominal axis of the suction nozzle 56 (axis Oₕ of the component-mounting head 22), and the amount of misalignment of the axis Oₕ of the head 22 with respect to the optical axis Oₛ of the component imaging device 30. These amounts of deviation or misalignment are stored in respective memory portions of the RAM 184, and are used to adjust the distances of movement of the component-mounting unit 24 to the component-supply position for receiving and holding the electronic component 54, and adjust the component-mounting angular position of the component-mounting head 22 and the distances of movement of the component-mounting head 22 to the component-mounting spot on the circuit substrate 12 when the electronic component 54 is mounted on the circuit substrate 12.

<Detection Assisting Kit>

The amount of deviation of the sucking-end position of the suction nozzle 56 may be detected according a nozzle-sucking-end-position detecting program stored in the ROM 182 and RAM 184. In the present electronic-component mounting system, the component-mounting unit 24 has the four component-mounting heads 22 which are arranged to use the suction nozzles 56 of different kinds accommodated in the nozzle accommodating device 150, as described above. Therefore, it is desirable to detect the amount of deviation of the sucking-end position of the suction nozzle 56 for each of the four component-mounting heads 22, and for each of the different kinds of the suction nozzles 56.

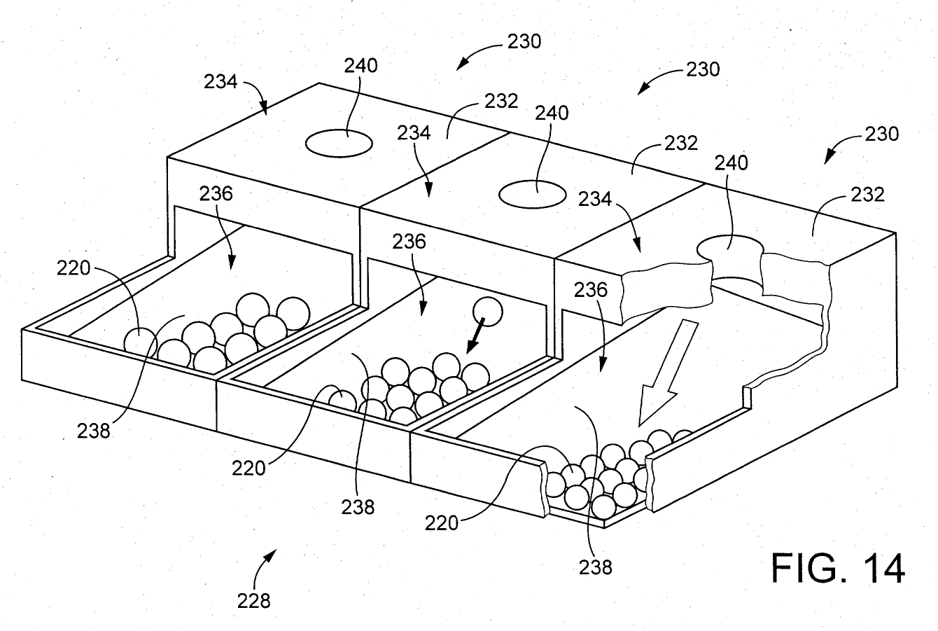

In view of the above-indicated desirability, the present electronic-component mounting system is provided with a detection assisting kit having a plurality of detecting tools, so that the amounts of deviation of the sucking-end positions of the suction nozzles 56 can be detected at one time. FIG. 14 shows an example of this detection assisting kit in the form of a detecting assisting kit 228, which has three tool containers in the form of ball containers 230 storing respective batches of detecting tools in the form of the balls 220. The three ball containers 230 are formed integrally with each other. Each of the ball containers 230 is of substantially box construction consisting principally of a return portion 234 having a top wall 232, and a pickup portion 236 not having a top wall. The ball container 230 has a straight bottom wall 238 which is entirely inclined diagonally of its rectangular shape, as indicated by an arrow in FIG. 14, such that the bottom wall 238 is highest at one longitudinal end (front end) thereof corresponding to the return portion 234, and lowest at the other longitudinal end (rear end) corresponding to the pickup portion 236 and such that the bottom wall is higher at one lateral end (left end as seen in FIG. 14) thereof than at the other side (right end). The rectangle of the bottom wall 238 has opposite long sides which are opposed to each other in direction in which the ball containers 230 are arranged. Thus, the bottom wall 238 has the lowest level at the front right corner of the ball container 230.

In each ball container 230 constructed as described above, the balls 220 tend to stay in the front end section of the pickup portion 236 which is remote from the inlet portion 234, as shown in FIG. 14. One of the balls 220 which is presently located at the front right corner of the ball container 230 is picked up by the suction nozzle 56. Namely, the center position of this ball 220 at the front right corner represents a predetermined tool-pickup position at which the presently selected ball 220 is received by the suction nozzle 56 to be detected (suction nozzle 56 under examination). When the sucking-end position of the suction nozzle 56 under examination is detected, the component-mounting head 22 carrying this suction nozzle 56 is moved to the tool-pickup position, that is, to a position right above the ball 220 located at the front right corner of the appropriate ball container 230. At this tool-pickup position, the head 22 is lowered and communicated with the negative-pressure source, to pick up the ball 220 at the front right corner. Thus, the ball 220 is held by suction on the sucking end face of the suction nozzle 56 under examination. Then, the ball 220 sucked on the suction nozzle 56 is elevated away from the pickup portion 236 of the ball container 230, together with the component-mounting head 22. At this time, the ball 220 which has been located adjacent to the elevated ball 220 rolls into the front right corner of the ball container 230.

The top wall 232 of the return portion 234 of each ball container 230 has an inlet aperture 240 formed through a central potion thereof. After the deviation of the sucking-end position of the suction nozzle 56 has been detected, the component-mounting head 22 carrying this suction nozzle 56 with the ball 220 held thereon is moved to a position right above the inlet aperture 240. In this position, the component-mounting head 22 is lowered to insert the nozzle portion 80 of the suction nozzle 56 together with the ball 220. Then, the suction nozzle 56 is communicated with the positive-pressure source, so that the ball 220 is released from the suction nozzle 56 and falls onto the bottom wall 238. Thus, the position of the inlet aperture 240 is a predetermined tool-return position at which the ball 220 is returned into the ball container 230. This tool-return position is spaced from the tool-pickup position n the longitudinal direction of the bottom wall 238. The ball 220 which has fallen onto the inclined bottom wall 238 rolls on this wall 238 toward the front right portion of the pickup portion 236 in which a batch of balls 220 stays.

In the ball container 230 constructed as described above, the inclined straight bottom wall 238 provides tool positioning means for locating one of the tools in the form of the balls 220 at the predetermined tool-pickup position. The batch of the balls 220 stays in the front portion of the pickup portion 236, and the balls 220 tend to roll downwards toward the front right corner of the ball container 230. Accordingly, the ball 220 located at the tool-pickup position (at the front right corner) is forced downwards by the adjacent balls 220 due to the inclination of the bottom wall 238. However, the ball 220 at the front right corner is kept there by portions of the upright walls which define the front right corner. In this respect, the upright walls constitute movement preventing means for preventing the ball 220 at the front right corner from being moved from the predetermined tool-pickup position. After the ball 220 is picked up from the tool-pickup position, one of the adjacent balls 220 rolls into the tool-pickup position. However, the balls 220 may not smoothly move toward the front right corner of the ball container 230, due to a so-called “bridging phenomenon” of the balls 220. To overcome this drawback, a suitable vibrating device such as a vibrator may be provided to vibrate or oscillate the ball container 230. In this case, the vibrating device functions a movement facilitating means for facilitating the movement of the balls 220 toward the tool-pickup position.

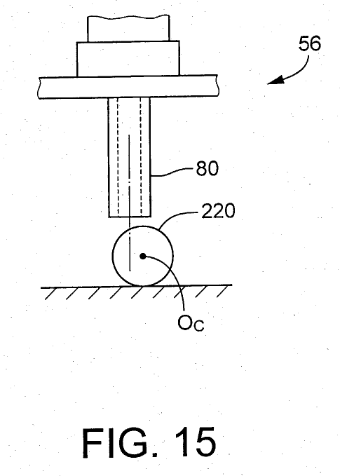

Even when the suction nozzle 56 is located at the predetermined tool-pickup position, the sucking-end position of the suction nozzle 56 may be misaligned with respect to the tool pickup position, for some reason, for instance, due to bending of the nozzle portion 80. That is, the sucking end face of the suction nozzle 56 may be more or less offset from the center O_{c} of the ball 220 at the tool-pickup position, as indicated in FIG. 15, even when the component-mounting head 22 is moved to move the suction nozzle 56 for alignment with the tool-pickup position. However, the application of a negative pressure to the ball 220 permits the ball 220 to be drawn onto the sucking end face of the suction nozzle 56 such that the center O_{c} of the ball 220 is aligned with the axis Oₙ of the sucking end portion of the suction nozzle 56, as indicated in FIG. 11A. This alignment is permitted owing to the spherical shape of the ball 220 having a part-spherical contact surface for contact with the sucking end face of the suction nozzle 56.

<Inspection of the Suction Nozzle 56 by Detecting the Sucking-End Position>

As shown in FIG. 1, the detection assisting kit 228 including the ball containers 230 is located adjacent to the circuit-substrate holding device 16, more precisely, on the left side of the holding device 16, as seen in FIG. 1. Described more specifically, the three ball containers 230 are fixedly disposed on the machine base 10. When all of the suction nozzles 56 are inspected for the amounts of deviation of their sucking-end positions, according to a predetermined inspecting program, the component-mounting unit 24 is moved to a position right above the nozzle accommodating device 150, and the component-mounting heads 22 receive the respective suction nozzles 56. Then, the component-mounting unit 24 is moved to a position right above the detection assisting kit 228, and the suction nozzles 56 pick up the appropriate balls 220 corresponding to the kinds of the suction nozzles 56. The component-mounting unit 24 is then moved to move each of the balls 220 to the imaging position right above the component imaging device 30, and the images of the balls 220 are successively taken by the component imaging device 30, to detect the sucking-end positions of the suction nozzles 56 which hold the respective balls 220. After the deviations of the sucking-end positions of the suction nozzles 56 have been thus detected, the component-mounting unit 24 is moved to the position right above the detection assisting kit 228, to return the balls 220 back into the appropriate ball containers 230. All of the suction nozzles 56 used by the present system can be inspected by repeating the series of operations described above. The series of operations may be performed at one time for all of the four component-mounting heads 22, to improve the efficiency of inspection of the suction nozzles 56. While the automatic inspection according to the predetermined inspecting program has been described, any desired one of the suction nozzles 56 may be manually inspected by manually controlling the appropriate devices through a data input device provided in the system.

The inspection of the suction nozzles 56 described above is effected by the method according to the present invention of detecting the sucking-end position of the suction nozzle. This inspecting or detecting method includes: a step of preparing a detecting tool; a step of holding the detecting tool by suction on the suction nozzle; a step of taking an image of the detecting tool as held by the suction nozzle; and a step of detecting a center position of the detecting tool, on the basis of image data representative of the taken image of the detecting tool. In a broad sense, the step of preparing the detecting tool is a step of manufacturing or purchasing the detecting tool, a step of providing the present electronic-component mounting system with the detection assisting kit 228 accommodating the detecting tool in the form of the ball 220. In a narrow sense, the step of preparing the detecting tool is a step of locating the detecting tool at the predetermined tool-pickup position, as in the present embodiment of the invention. In the case of the automatic inspection of the suction nozzle according to the inspecting program, the inspection may be effected at any desired time. For example, the automatic inspection is initiated when a predetermined inspecting condition is satisfied. For instance, the automatic inspection is initiated when a predetermined cumulative operating time of the component-mounting operation has passed, or when the component-mounting operation has been performed on a predetermined number of circuit substrates 12.

<Other Embodiments or Modifications>

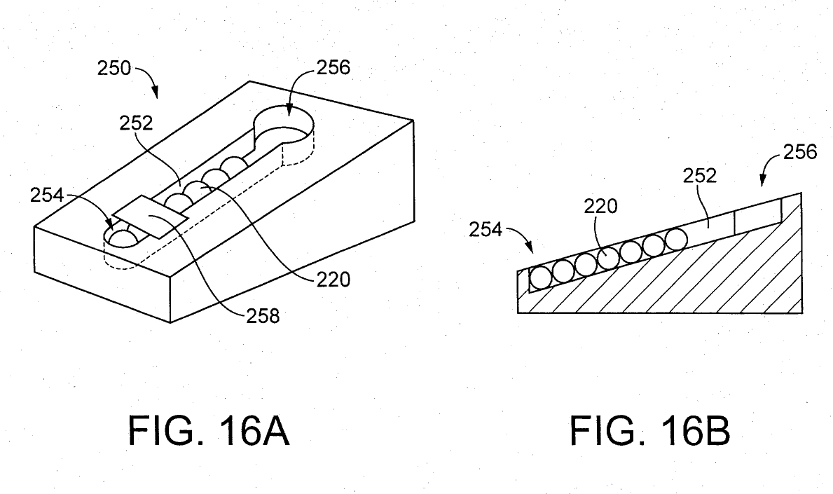

While each ball container 230 of the detection assisting kit 228 provided in the first embodiment is of box construction, this ball container 230 may be replaced by a ball container 250 as show in the perspective view of FIG. 16A and the cross sectional view of FIG. 16B. This ball container 250 serving as a tool container is a substantially solid block having an inclined upper surface and a groove 252 which is formed in a central portion of the inclined upper surface such that the groove 252 has a constant depth and a bottom wall parallel to the upper inclined surface. The groove 252 of the ball container 250 accommodates a succession of a plurality of balls 220. The width and depth of the groove 252 are slightly larger than the diameter of each ball 220, over an almost entire length of the groove 252. The groove 252 has a pickup portion 254 at its lower end portion, and a return portion 256 at its upper end portion, which has a width larger than the other portion. The pickup portion 254 defines a predetermined tool-pickup position at which the lowermost ball 220 is picked up by the suction nozzle 56, while the return portion 256 defines a predetermined tool-return position at which the ball 220 is released from the suction nozzle 56 and returned into the groove 252. The walls defining the pickup portion 254 provide movement-preventing means for preventing the lowermost ball 220 from being moved from the tool-pickup position. This movement-preventing means cooperates with the bottom wall of the groove 252 to constitute positioning means for locating one of the tools in the form of the balls 220 at the predetermined tool-pickup position. The ball container 250 is provided with a covering 258 which closes the opening of the groove 252, at a position which is adjacent to the pickup portion 254 in the upward direction. This covering 258 functions as removal-preventing means for preventing the second lowermost ball 220 from jumping out of the groove 252 when the lowermost ball 220 in the pickup portion 254 is picked up by the suction nozzle 56. Thus, the covering 258 permits a smooth movement of the ball 220 adjacent to the lowermost ball 220, into the pickup portion 254. The ball 220 the image of which has been taken is lowered with the suction nozzle 56 at the tool-return position and returned into the groove 252 through the return portion 256, so that this ball 220 rolls down on the inclined bottom of the groove 252 and joins the succession of the balls 220 as the last or uppermost one.

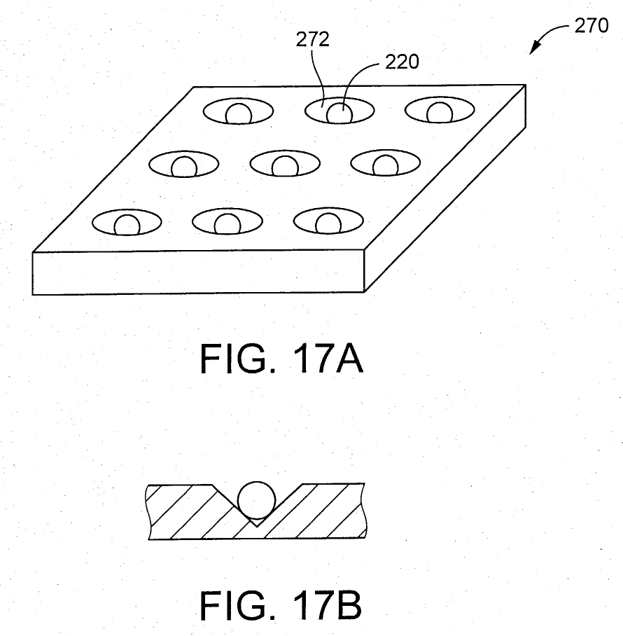

A further embodiment of this invention is provided with a ball container 270 as shown in FIGS. 17A and 17B. This ball container 270 serving as a tool container takes the form of a plate having a comparatively large thickness and a plurality of recesses 272 (nine recesses 272) in which the respective balls 220 are accommodated. As shown in FIG. 17B, each recess 272 is conical and has a V shape in cross section, so that the ball 220 accommodated in the recess 27 is positioned. Thus, the conical recesses 272 function as tool positioning means for locating each ball 220 at a predetermined tool-pickup position. Position data indicative of the positions of the recesses 272 are stored in the ROM 182, and used to position the suction nozzles 56 for holding the respective balls 220 in the respective recesses 272. The position data are used also when the balls 220 are returned into the recesses 272 after the images of the balls 220 are taken. When each ball 220 is returned, the ball 220 is released from the suction nozzle 56 when the ball 220 is almost aligned with the center of the recess 272.

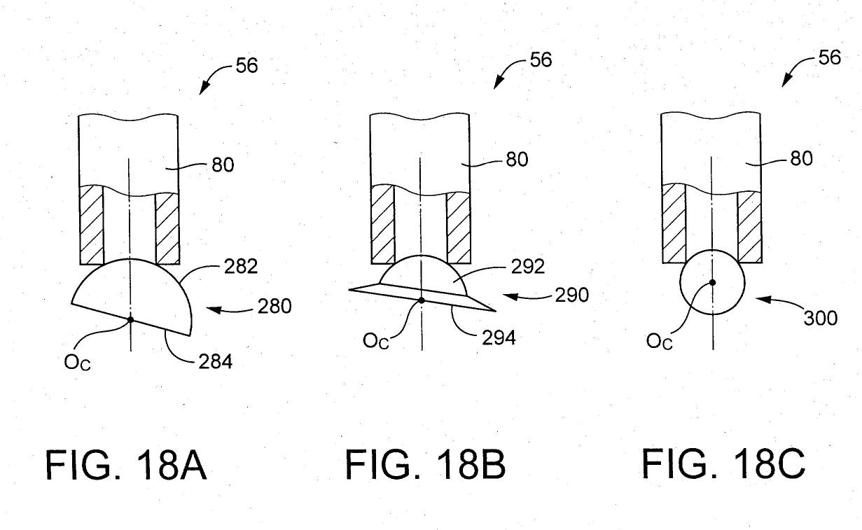

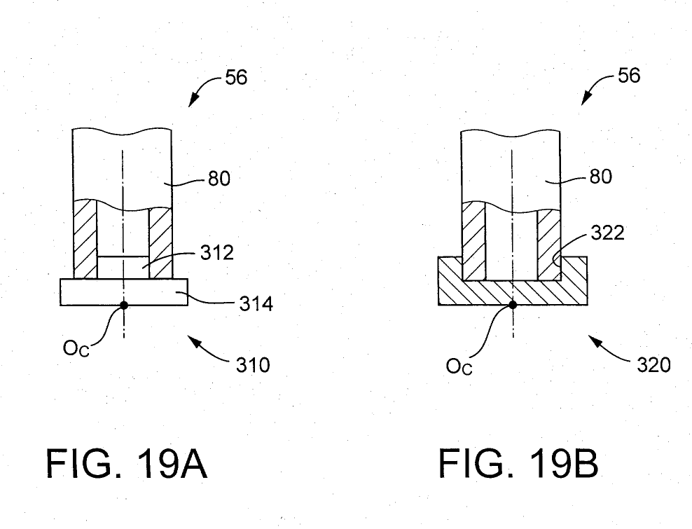

There will be described modified forms of the detecting tool other than the balls 220 described with respect to the first, second and third embodiments of FIGS. 14, 16 and 17. The ball 220 has a diameter larger than the outside diameter of the That is, FIGS. 18 and 19 show those modified forms of the detecting tool as held by suction on the sucking end face of the suction nozzle 56. The spherical ball 220 having the diameter larger than the outside diameter of the suction nozzle 56 may be replaced by a hemispherical detecting tool 280 shown in FIG. 18A. This hemispherical detecting tool 280 has a part-spherical portion surface 282 and a circular flat surface 284. The detecting tool 280 is held by suction at its hemispherical surface 282 on the sucking end face of the nozzle portion 80 of the suction nozzle 56. The circular flat surface 284 is an imaged surface an image of which is taken by the component imaging device 30. In the example of FIG. 18A, the flat surface 284 of the detecting tool 280 as held by the suction nozzle 56 is inclined with respect to the horizontal plane, due to some amount of misalignment of the suction nozzle 56 with respect to the axis of the component-mounting head 22. In this case, however, the center O_{c} of the circular flat surface 284 lies on the axis of the nozzle portion 80 of the suction nozzle 56. Accordingly, the position of the sucking end face of the suction nozzle 56 can be detected by taking an image of the circular flat surface 284 and processing image data representative of this image of the circular flat surface 284, which represents the profile of the surface 284. Since the flat surface 284 is inclined, the image of the surface 284 is elliptical. Where the hemispherical detecting tool 280 is held by suction such that the circular flat surface 284 is inclined, the image taken by the component imaging device 30 includes an edge portion of the hemispherical surface 282. In this respect, it is desirable that the flat surface 284 is colored white while the hemispherical surface 282 is colored black. In this case, the edge portion of the hemispherical surface 282 is hidden in the black background, and only the flat surface 284 is clearly imaged.

The hemispherical detecting tool 280 may be replaced by a hat-shaped detecting tool 290 as shown in FIG. 18B. This detecting tool 290 also has a hemispherical surface 292 as the contact surface and a circular flat surface 294 as the imaged surface. However, the circular flat surface 294 has a diameter larger than the diameter of the hemispherical surface 292, in the presence of an annular brim outwardly extending from the circular edge of the hemispherical surface 292. In this case, too, the center O_{c} of the circular flat surface 294 is always aligned with the axis of the nozzle portion 80 of the suction nozzle 56. The hat-shaped detecting tool 290 is advantageous over the hemispherical detecting tool 290 in that the brim prevents an edge portion of the hemispherical surface 292 from being included in the front image taken by the component imaging device 30 where the surface 292 is white. Further, the use of this hat-shaped detecting tool 290 permits the detection of the sucking-end position of the suction nozzle 56 on the basis of a silhouette image of the detecting tool 290. Further, the ball 220 whose diameter larger than the outside diameter of the suction nozzle 56 may be replaced by a spherical ball 300 shown in FIG. 18C, which has a diameter is smaller than the outside diameter of the suction nozzle 56 (more precisely, the outside diameter of the nozzle portion 80), provided that the sucking end face of the nozzle portion 80 does not have an adverse influence on the image taken by the component imaging device 30.

It is also possible to use detecting tools 310, 320 shown in FIGS. 19A and 19B, respectively. The detecting tool 310 consists of a circular disk portion 314 and a shaft portion 312 extending axially from one of opposite surfaces of the disk portion 314. The shaft portion 312 has a diameter only slightly smaller than the inside diameter of the nozzle portion 80 of the suction nozzle 56. The detecting tool 310 is held by suction on the suction nozzle 56 such that the shaft portion 312 is fitted within the bore of the nozzle portion 80. Since the axis of the shaft portion 312 is aligned with the axis of the disk portion 314, the center O_{c} of the lower surface of the disk portion 314 lies on the axis of the sucking end portion of the suction nozzle 56. The lower surface of the disk portion 314 is imaged as the imaged surface, and the center position of the sucking end of the suction nozzle 56 is detected by processing image data representative of the image of the lower surface of the disk portion 314. In this detecting tool 310, an outer circumferential surface of the shaft portion 312 and an annular portion of the inner surface of the disk portion 314 constitute the contact surface for contact with the suction nozzle 56.

The detecting tool 320 shown in FIG. 19B takes the form of a circular disk having a circular recess 322 formed in one of its opposite surfaces. The circular recess 322 has a diameter slightly larger than the outside diameter of the nozzle portion 80. The detecting tool 320 is held by suction on the suction nozzle 56 such that the sucking end portion of the nozzle portion 80 is fitted in the recess 322. The circular recess 322 is concentric with the circular disk, so that the center O_{c} of the lower surface of the detecting tool 320 lies on the axis of the sucking end portion of the suction nozzle 56. The lower surface of the tool 320 is imaged as the imaged surface, and the center position of the sucking end face of the suction nozzle 56 can be detected on the basis of image data representative of the image of the lower surface. In the detecting tool 320, an inner circumferential surface and a circular bottom surface of the recess 322 constitute the contact surface for contact with the suction nozzle 56. The detecting tools 310 and 320 of FIGS. 19A and 19B are positioned in the XY plane perpendicular to the axial direction of the suction nozzle 56, by the inner or outer circumferential surface of the nozzle portion 80. Although these detecting tools 310, 320 are relatively difficult to be automatically aligned with the suction nozzle 56 upon holding of the detecting tools 310, 320 by suction, the use of the detecting tools 310, 320 permit accurate detection of the sucking-end position of the suction nozzle 56.

The electronic-component mounting system to which the illustrated embodiments are applied is of XY robot type, the principle of the present invention using a detecting tool for detecting the sucking-end position of the suction nozzle is equally applicable to an electronic-component mounting system of rotary head type which includes a component-mounting unit having a plurality of component-mounting heads which are equiangularly spaced from each other along a circle and which are successively and intermittently moved along the circle and stopped at a plurality of working positions including a component-receiving position at which each component-mounting head receives an electronic component, and a component-mounting position at which the head transfers the electronic component onto a circuit substrate. The electronic-component mounting system of rotary head type further includes a component-supplying device having an array of a plurality of component feeders and operable to move a selected one of the component feeders to a component-supply position aligned with the component-receiving position of the component-mounting unit. The system of rotary head type further includes a circuit-substrate holding device which is arranged to hold the circuit substrate and operable to move the circuit substrate such that predetermined component-mounting spots on the circuit substrate are sequentially located at the component-mounting position of the component-mounting unit. In the system of rotary head type, a component imaging device is disposed at a component-imaging position between the component-receiving position and the component-mounting position, so that the electric component held by the suction nozzle carried by the component-mounting head located at the component-imaging position is imaged by the component imaging device. In this system of rotary head type, a detection assisting kit is disposed adjacent to the component-supply position of the component-supplying device, for automatically detecting the sucking-end position of the suction nozzles.

In the illustrated embodiments, the component imaging device 30 is a component imaging camera (CCD camera). However, a line sensor may be used as the component imaging device. The line sensor has an array of sensing elements and is moved at a constant speed relative to the object to be imaged, in a direction perpendicular to the direction in the direction of arrangement of the sensing element, so that a two-dimensional image of the object is obtained.

While the preferred embodiments of the present invention have been described in detail, for illustrative purpose only, it is to be understood that the present invention may be embodied with various changes and improvements, such as those described in the SUMMARY OF THE INVENTION, which may occur to those skilled in the art.

What is claimed is:

1. A method of detecting a position of a sucking end of a suction nozzle arranged to hold an object by suction at said sucking end under a negative pressure, comprising the steps of:
preparing a detecting tool having (a) a contact surface for contact with said sucking end of said suction nozzle when the detecting tool is held by suction by said suction nozzle, and (b) an imaged surface which is opposite to said contact surface and which is imaged when said detecting tool is held by suction by said suction nozzle such that a center of an image of said imaged surface taken in an axial direction of said suction nozzle lies on an axis of said suction nozzle;
holding said detecting tool by suction on said suction nozzle such that said contact surface is in contact with said sucking end;
taking said image of said imaged surface of said detecting tool in said axial direction of said suction nozzle; and
detecting a center position of said sucking end of said suction nozzle in a plane perpendicular to said axial direction, with respect to a nominal position of said axis of the suction nozzle, on the basis of image data representative of said image of said image surface.

2. A method according to claim 1, wherein said step of preparing a detecting tool comprises preparing a detecting tool such that said image of said imaged surface of said detecting tool is distinguishable from any other image within a field of vision in which said image of said imaged surface is taken.

3. A method according to claim 1, wherein said step of taking said image of said imaged surface of said detecting tool comprises taking a front image of said detecting tool with a light reflected from said imaged surface.

4. A method according to claim 1, wherein said step of preparing a detecting tool comprises preparing a spherical tool as said detecting tool.

5. A method according to claim 4, wherein said spherical tool is a ball having a diameter larger than an outside diameter of said suction nozzle.

6. A method according to claim 4, wherein said spherical tool is a ball having a diameter smaller than an outside diameter of said suction nozzle.

7. A method according to claim 1, wherein said step of preparing a detecting tool comprises preparing a detecting tool having a part-spherical surface as said contact surface.

8. A method according to claim 7, wherein said imaged surface of said detecting tool consists of a flat surface having a center which is aligned with a center of an imaginary sphere which is partially defined by said part-spherical surface.

9. A method according to claim 1, wherein said step of preparing a detecting tool comprises preparing a detecting tool which is positioned relative to said suction nozzle such that said contact surface is in contact with at least one of an inner circumferential surface and an outer circumferential surface of a sucking end portion of said suction nozzle which has said sucking end.

10. A method according to claim 1, wherein said object is an electric component to be mounted on a circuit substrate, and said suction nozzle is a part of a component-mounting device operable to mount said electric component on said circuit substrate.

11. A detecting tool for detecting a position of a sucking end of a suction nozzle arranged to hold an object by suction at said sucking end under a negative pressure, comprising:
a first portion having a contact surface for contact with said sucking end of said suction nozzle when the detecting tool is held by suction by said suction nozzle: and
a second portion having an imaged surfaced which is opposite to said contact surface and which is imaged when said detecting tool is held by suction by said suction nozzle such that a center of an image of said imaged surface taken in an axial direction of said suction nozzle lies on an axis of said suction nozzle.

12. A detection assisting kit for detecting a position of a sucking end of a suction nozzle arranged to hold an object by suction at said sucking end under a negative pressure, comprising:
at least one detecting tool each of which has (a) a contact surface for contact with said sucking end of said suction nozzle when the detecting tool is held by suction by said suction nozzle, and (b) an imaged surface which is opposite to said contact surface and which is imaged when said detecting tool is held by suction by said suction nozzle such that a center of an image of said imaged surface taken in an axial direction of said suction nozzle lies on an axis of said suction nozzle; and
a tool container accommodating said at least one detecting tool and including tool-positioning means for locating one of said at least one detecting tool at a predetermined tool-pickup position at which said one detecting tool is picked up by suction by said suction nozzle.

13. A detection assisting kit according to claim 12, wherein each of said at least one detecting tool is a spherical tool, and said tool-positioning means includes a bottom wall of said tool container, said bottom wall including an inclined portion a surface of which is inclined to permit said spherical tool to roll down thereon toward said predetermined tool-pickup position at which said surface has a lowest level.

14. A detection assisting kit according to claim 13, wherein said tool container includes (i) a return portion having a predetermined tool-return position which is spaced from said predetermined tool-pickup position and at which said spherical tool is returned by said suction nozzle into said tool container, and (ii) a pickup portion having said predetermined tool-pickup position, and wherein said inclined portion of said bottom wall is continuously inclined downwards from said tool-return position to said tool-pickup position.
